(19) United States
(12) Patent Application Publication
(10) Pub. No.: US 2017/0296972 A1
(43) Pub. Date: Oct. 19, 2017

(54) METHOD FOR MAKING TWO-DIMENSIONAL MATERIALS AND COMPOSITE MEMBRANES THEREOF HAVING SIZE-SELECTIVE PERFORATIONS

(71) Applicant: Lockheed Martin Corporation, Bethesda, MD (US)

(72) Inventors: Steven W. Sinton, Palo Alto, CA (US); Peter V. Bedworth, Los Gatos, CA (US); Sarah M. Simon, Baltimore, MD (US); Jacob Louis Swett, Redwood City, CA (US); Scott E. Heise, San Jose, CA (US)

(73) Assignee: Lockheed Martin Corporation, Bethesda, MD (US)

(21) Appl. No.: 15/099,482

(22) Filed: Apr. 14, 2016

(51) Int. Cl. B01D 63/08; B01D 61/38

(52) U.S. Cl. CPC B01D 63/081; B01D 63/087; B01D 61/38; B01D 2323/46

(57) ABSTRACT

Two-dimensional materials having apertures in their basal planes are described, where at least a portion of the apertures are occluded with a selectively introduced occluding moiety. Occluding moieties that pass into apertures function to occlude apertures. Composite membranes are described having a porous substrate with a two-dimensional material disposed on the membrane and covering only a portion of the pores, wherein at least a portion of uncovered substrate pores are occluded. Pore occlusion can be achieved by introduction of an occluding particle optionally followed by chemical reaction, deformation or swelling of the particle to facilitate occlusion of pores. Two-dimensional materials covering substrate pores can be size-selected and optionally functionalized providing for selective permeability through composite membranes. Methods for occluding defects and apertures in two-dimensional materials and for selectively occluding pores in composite membranes are provided. Selectively occluded materials and membranes are useful in filtration and other applications.

The present disclosure generally relates to graphene-based materials and other two-dimensional materials and to composite materials in which the two-dimensional materials are disposed, and, more specifically, to methods for occluding at least a portion of undesired apertures, defects or pores in such materials.

### BACKGROUND

Graphene represents an atomically thin layer of carbon in which the carbon atoms reside at regular lattice positions. Synthesizing graphene in a regular lattice is difficult due to the irregular occurrence of defects in as-synthesized two-dimensional materials. Such defects will also be equivalently referred to herein as “apertures,” or “holes.” Of particular interest for practical applications, for example, involving filtration, separation or selective containment, is the ability to make defect-free material of practical dimension. Processing and handling, which in most instances is required to use these materials, can also induce further defects in as-synthesized graphene and other two-dimensional materials. FIG. 1 shows an illustrative scanning electron microscope (SEM) image of defects and apertures that can be present in a graphene sheet on a porous substrate.

Graphene has garnered widespread interest for use in a number of applications due to its favorable mechanical and electronic properties. Applications that have been proposed for graphene include, for example, optical devices, mechanical structures, and electronic devices. In addition to the foregoing applications, there is increasing interest in graphene for filtration or separation applications. In such applications, the presence of defects above a cutoff size or outside of a selected size range can be undesirable. On the other hand, defects below a critical size required for application-specific separation may be useful from a permeability perspective, as long as such defects do not negatively impact the integrity of the graphene.

The term “perforated graphene” is used herein to denote a graphene sheet with defects in its basal plane, regardless of whether the defects are natively present (intrinsic) or intentionally produced. Such apertures can be present in both single-layer and few-layer graphene (e.g., less than 10 graphene layers), multiple sheets of single layer graphene, as well as multiple sheets of few-layer graphene stacked upon one another. Multiple layer graphene includes those that are formed by stacking of independently synthesized single layer graphene as well as graphene grown in the form of multiple layers. The term “size-selective perforated graphene” is used herein to denote a graphene sheet with perforations or defects in its basal plane within a selected size range. Size-selective perforations in graphene include perforations that are intentionally introduced as well as intrinsic or native defects within a selected size range. The term size is used herein to refer to the dimensions of the perforation with respect to what fluids, chemical or particle can pass through or not pass through the perforation. A perforation may have any geometry including irregular geometry. Passage of a fluid and/or chemical species and/or particle through perforations in graphene depends at least in part on the size (i.e., the dimensions) of the perforations, but also can depend upon the chemical functionalization of the graphene at the perforation and on application of a voltage bias to the graphene. In one aspect of the inventive concepts disclosed herein, undesirable larger defects in graphene are mitigated employing methods of the inventive concepts disclosed herein.

Composite materials, typically composite membranes, in which a graphene sheet or other two-dimensional material is disposed on a porous substrate are useful in a variety of applications and particularly in filtering, selective barrier, or separation applications. A graphene sheet is disposed on a surface of a porous substrate, such that pores in the substrate are covered by the graphene sheet. Non-perforated, defect-free graphene, or graphene with defects below a application specific critical size, disposed over substrate pores prevents passage of fluids and/or chemical species and/or particles into and through the substrate pores. Introduction of size-selected perforations in the graphene sheet disposed on such pores provides for size-selected passage of fluids and/or chemical species and/or particles into and through the substrate pores. As noted above, size of graphene perforations is one of several factors that affect passage through the perforations. Composite membranes where pores in the substrate are covered by graphene having size-selective perforations are useful in a variety of filtering, separation and selective containment, and barrier layer applications. Due to the presence of intrinsic or native defects in graphene which can be created during synthesis and defects that are introduced by processing and handling, it is difficult to obtain composite membranes in which all or even the majority of substrate pores are covered by defect-free graphene or size-selected perforated graphene. Methods for reducing or eliminating flow through membrane substrate pores not covered by defect-free graphene or size-selected perforated graphene, and which do not significantly reduce the function of the membrane for filtration or separation would be particularly useful for preparation of practical filtration and separation materials. There are a number of methods available in the art for intentionally introducing perforations of desired size into graphene and other two-dimensional materials. Methods include among others, ion beam and particle beam irradiation such as with nanoparticles, UV-ozone exposure and patterning defects during synthesis of the two-dimensional material. Several techniques have been described for reducing or healing holes in graphene or composite membranes. For example, Zan et al. reports a nanoscale etching and reknitting process for healing graphene holes. This process is conducted over nanoscale dimensions and has limited applicability to materials of macroscopic dimensions. Published US application 2015/0122727 reports methods employing various means of deposition of materials to heal holes in graphene or plug holes in composite membranes. Methods reported include atomic layer deposition (ALD), chemical vapor deposition (CVD), and interfacial reaction.

In view of the foregoing, simplified techniques that allow a plurality of perforations having a desired size and chemistry to be prepared in graphene-based materials and other two-dimensional materials and reduces or prevents non-selective passage through the materials would be of considerable benefit in the art. Additionally, simplified techniques for the preparation of composite membranes in which substrate pores are covered by size-selected graphene or other two-dimensional material in which non-selective flow is prevented and which are useful in filtering or separation applications would also be of considerable interest. The present disclosure provides such methods and in particular provides composite membranes in which passage through substrate pores is mediated and/or controlled by size-selective perforated graphene.

### SUMMARY OF THE INVENTION

The present disclosure describes methods for at least partially occluding flow of fluid and/or chemical species and/or particles through apertures within sheets of graphene-based materials or other two-dimensional materials. The present disclosure also describes related methods for occluding pores in a composite membrane to generate membranes where flow through the pores is mediated through size-selected perforated graphene or other two-dimensional materials.

In one aspect, the methods involve reacting an occluding moiety with defects or apertures in sheets of graphene-based materials or other two dimensional materials or catalyzing a reaction in such defects or apertures to mitigate the defect or aperture, where mitigation includes closing or healing of the defect or aperture or decreasing the size of the defect or aperture. In healing the graphene-based material, perforations in the graphene-based material may or may not be healed. Fluorescently tagged moieties may be used to verify healing or failure of healing. In an embodiment, reacting or catalyzing a reaction is directed to defects or aperture having a certain size, geometry or functionality. The methods can involve flowing a chemical moiety through the perforations in a sheet of the two-dimensional material such that only the moiety passing through the sheet of the two-dimensional material is available to react or catalyze a reaction with the defect or aperture, i.e., with chemical moieties at the defect or aperture. By choosing the occlusion technique and the occluding moiety, larger apertures in a sheet of a two-dimensional material can become occluded, for example, in preference to smaller apertures, producing a sheet of two dimensional material with improved flow selectivity. In some cases it can be desirable to occlude substantially all the apertures in a sheet of a two-dimensional material, such that the treated sheet of two-dimensional material is substantially impervious to flow of fluids or chemical species there through. The sheets of a two-dimensional material having at least partially occluded apertures prepared according to the embodiments described herein can be used in separation techniques and systems, although they are also usable in other applications, such as selective barrier applications. In an embodiment, sheets of two-dimensional material having at least partially occluded apertures and particularly sheets where the majority (greater than about 50%) of the apertures or wherein substantially all of the apertures are occluded can be used as starting material for preparation of size-selective perforated graphene or other two-dimensional material, wherein perforations of a selected size range are introduced into the sheets in which apertures have been occluded.

In some embodiments, perforated graphene-based material having at least a portion of its apertures occluded with a chemical moiety is described herein.

In another aspect, the disclosure relates to methods of making composite membranes in which a sheet of graphene-based material or other two-dimensional material is disposed on a surface of a porous substrate wherein at least a portion of the pores of the substrate are covered by the sheet of two-dimensional material and in which pores in the substrate, that are not covered or are only partially covered, are occluded with one or more occluding moieties such that fluid or other chemical moieties cannot pass through the occluded pores. The size of the moiety provides a selectivity for which size of pores will be occluded. The methods herein in certain embodiments ensure that pores in the composite membrane that are covered by the two-dimensional material are not occluded which results in composite membranes with minimal reduction in membrane function. Composite membranes with occluded pores include those in which a portion of the uncovered substrate pores are occluded, those in which a majority (50% or more) of the uncovered substrate pores are occluded and those in which substantially all (95% or more) of the uncovered pores are occluded. The two-dimensional material covering the pores may be defect and aperture-free, or may be size-selective perforated. In an embodiment, the two-dimensional material of the composite membrane is perforated after treatment to occlude pores that are not covered by the two-dimensional material. Size-selective perforation after pore occlusion provides composite membranes useful for size-selective filtration. Composite membranes in which uncovered pores are occluded are useful, for example, as starting materials for preparation of size-selective filtration membranes.

The disclosure also relates to composite membranes prepared by the methods herein wherein at least a portion of the uncovered pores of the substrate are occluded.

In an embodiment, the method of occluding uncovered pores includes introducing an occluding moiety into an uncovered pore. In an embodiment, the occluding moiety is one or more particles sized for at least partial entrance into the uncovered pore, but which do not pass through the pore. In an embodiment, the one or more particles are deformable after introduction into the pore by application of energy, for example, application of pressure, heat, light, particularly light of selected wavelength, or an ion or particle beam. In an embodiment, the one or more particles carry one or more chemical reactive groups which react or can be activated to react with compatible reactive groups in the pores, on the surface of the substrate or on other particles to facilitate anchoring of the one or more particles to occlude a pore.

In an embodiment, the occluding particles are swellable after entry into a pore. For example, the material from which the particle is made is selected such that it swells when contacted by material which is absorbed into the particle. In an embodiment, the particle is swellable on contact with a selected absorbable fluid. In an embodiment, the absorbable fluid is water or an aqueous solution. In an embodiment, the absorbable fluid is an organic solvent. In an embodiment, the absorbable fluid is a polar organic solvent. In an embodiment, the absorbable fluid is a non-polar organic solvent. In an embodiment, the occluding particles are hydrogel particles which swell on absorption of water. In an embodiment, the occluding particles are polymer particles which swell on adsorption of an organic solvent, such as cross linked organic thermoset polymers, for example.

In an embodiment, the one or more occluding particles are monodisperse with respect to particle size. In an embodiment, the one or more occluding particles have a selected range of particles sizes. In an embodiment, after initial occlusion of a pore by one or more particles of a given first size, additional secondary particles of a size less than that of the initial particles can optionally be introduced into a pore to further facilitate occlusion of the pore or to facilitate anchoring. In this embodiment, the first and secondary particles optionally carry reactive groups to facilitate reaction with compatible reactive groups on the surface of pores or on other particles. In this embodiment, after particle introduction, energy is optionally applied, for example, in the form of heat, light or ion beam irradiation to facilitate anchoring in the pores. The use of particles of different sizes can result in higher packing densities which can provide better occlusion of pores. Particle compositions can, for example, be employed for occlusion, which have bimodal or trimodal particle size distributions.

In an embodiment, the pore occluding moiety is one or more monomers or oligomers which are introduced into an uncovered pore and polymerized therein to form a polymer and occlude the pore. Polymerization may be activated by any known means that is not detrimental to the two-dimensional material or to the substrate, including for example, activation by heating to a selected temperature, irradiation with light of selected wavelength, and/or introduction of a polymerization catalyst, or other methods (see, for example, US Patent Application filed herewith, entitled SELECTIVE INTERFACIAL MITIGATION OF GRAPHENE DEFECTS, Atty. Docket No. 111423-1097, incorporated herein in its entirety) In some embodiments, a polymerization catalyst may be activated by application of heat, light or other form of energy.

In an embodiment, the pores of the substrate can be shaped along their length to facilitate occlusion by one or more particles. For example, the pores may be tapered where the size of the opening into a pore (e.g., the pore diameter) is larger than the size of the exit from the pore. In an embodiment, the pores of the substrate can be shaped at one or both pore openings (entrance or exit openings) to facilitate occlusion by one or more particles. Substrate pores may be shaped to have a desired geometry, e.g., circular, oval, rectangular, slit, square mesh, or the like to facilitate occlusion by one or more particles. Pores may be provided with internal ridges or ledges to facilitate occlusion by one or more particles. The lip or ridge may be at the top of the pore. The size of the exit from the pore (e.g., the exit diameter) may be decreased with respect to the pore opening to facilitate occlusion by particles. Shaping of pores may be combined with use of deformable particles. Shaping of pores may be combined with the use of particles carrying one or more reactive groups and in this embodiment shaped pores or the entrance or exit of the pores can be provided with compatible reactive groups to facilitate anchoring in the shaped pores. Shaping of the pores may be combined with any particle occluding method described herein. Shaping of the pores may be combined with polymerization of monomer and/or oligomers in shaped pores to occlude the pores.

In another embodiment, pore occlusion is obtained without introduction of an occluding moiety. In this embodiment, uncovered pores are occluded by the deformation or swelling of the substrate material forming the pore. In this embodiment, uncovered pores are selectively contacted to induce deformation or swelling of the substrate forming the pore to occlude the pore. Contacting can, for example, be with energy such as heat, light or an ion beam. Contacting can, for example, be with an absorbable fluid, such as water, aqueous solution or organic solvent, such that the substrate material at the pore swells to occlude the pore. In a related embodiment, the pores are provided with a deformable or swellable coating distinct from the substrate material. In this embodiment, selective contacting of uncovered pores with energy in the form, for example, of heat, light or an ion beam deforms the pore coating to occlude the pore. In this embodiment, where the coating is swellable, selective contacting of an uncovered pore with an absorbable fluid results in swelling to occlude the pore. Swellable coatings can, for example, be formed from swellable hydrogels or swellable polymers.

In an embodiment, the particles or other substrate pore occluding moieties are themselves selectively permeable having permeability that is selected for a given application. Permeable materials could include hydrogels, polymers, proteins, zeolites, metal-organic framework materials, or thin film solution membranes. The particles could also be covered with a semipermeable layer. An example would be a silica particle covered with polyethylene glycol. In an embodiment, the occluding particles are made at least in part of hydroxycellulose which is semi-permeable.

In an embodiment, particles, other occluding moieties, monomers, oligomers and optional polymerization catalysts, are introduced selectively into substrate pores that are not covered by two-dimensional material (uncovered substrate pores) by a flow of fluid, including liquid or gas. The flow of fluid or gas carrying the occluding moieties will not enter covered substrate pores. In an embodiment, selective introduction employs application of a cross-flow of fluid along the membrane and application of pressure. The cross-flow carrying occluding moieties is applied along the surface of the composite membrane upon which the two-dimensional material is disposed. In an embodiment, a flow of particles is applied to the top surface of a composite membrane and particles enter uncovered pores. The introduction step is optionally followed by a step of application of energy, a curing step or other step to facilitate anchoring of particles. Thereafter a cleaning step may be applied to the top surface of the composite material to remove particles that have not entered uncovered pores. Cycles of a particle introduction step, optional anchoring steps and a cleaning step may be repeated to achieve a desired level of pore occlusion. The effectiveness of pore occlusion can be assessed by flow rate measurements through an occluded composite membrane. More specifically, flow rate of a selected moiety (fluid, chemical species or particle) of a given size can be used to assess the effectiveness of substrate pore occlusion. In an embodiment, two or more of such cycles are performed. In an embodiment, five or more of such cycles are performed. In an embodiment, 9 or more of such cycles are performed.

In an embodiment, a pore occlusion process includes introduction of occluding moieties, more specifically particles, into substrate pores that are not covered by two-dimensional material (uncovered substrate pores). In an embodiment, a pore occlusion process further includes a step of removing occluding moieties that are not within substrate pores from the composite membrane. Introduction and removal (cleaning) steps can be repeated until a desired level of occlusion is achieved. In an embodiment, as described herein, a step of application of energy or chemical reaction can be applied after introduction of occluding moieties into substrate pores to facilitate anchoring of the moieties in the substrate pore.

In an embodiment, the methods herein for occluding defects, apertures or uncovered substrate pores are combined with methods of detection of defects or apertures in the two-dimensional material, such that occlusion methods are selectively applied to those portions of a sheet of two-dimensional material or those portions of a composite membrane where occlusion is needed. Such detection methods can include localized application of a selected assay fluid, e.g., a detectible gas, such as SF₆, to the two-dimensional material or to the composite membrane to detect the location (or approximate location) of defects, apertures or uncovered pores by passage of the assay fluid. Detection methods can also include localized resistance or capacitance measurement, where a change in resistance or capacitance is an indication of a defect or aperture. Detection methods can further include the localized detection of passage of analytes, particles, electrons or light, e.g., UV or visible light, through defects, apertures or through uncovered pores.

The foregoing has outlined rather broadly the features of the present disclosure in order that the detailed description that follows can be better understood. Additional features and advantages of the disclosure will be described hereinafter. These and other advantages and features will become more apparent from the following description.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows an illustrative scanning electron microscope (SEM) image of defects and apertures that can be present in a graphene sheet on a porous substrate. The illustrated graphene sheet has been transferred to an etched silicon nitride film in a rigid silicon support to create a composite membrane. The diameter of arrayed substrate pores is 600 nm. Visible apertures in the graphene film appear black and range in size from approximately 10 nm (limit of SEM resolution) to 600 nm (fully uncovered substrate pore).

FIG. 2 shows an illustrative schematic demonstrating how a perforated graphene sheet or sheet of another two-dimensional material can undergo backside functionalization according to inventive concepts described herein.

FIG. 3 shows an illustrative schematic demonstrating how a perforated graphene sheet or sheet of another two-dimensional material can undergo occlusion by flowing a catalyst there through according to inventive concepts described herein.

FIG. 4 shows an illustrative schematic demonstrating how a perforated graphene sheet or sheet of another two-dimensional material can undergo occlusion with a carbonaceous material or a non-carbonaceous material in the presence of a light ion beam, or a high temperature annealing step according to inventive concepts described herein.

FIG. 5 shows an illustrative schematic demonstrating how apertures in multiple layered graphene sheets or sheets of other two-dimensional materials can become differentially occluded according to inventive concepts described herein.

FIG. 6 shows an illustrative schematic demonstrating occlusion of uncovered substrate pores in a composite membrane having a graphene-based material sheet disposed upon a porous substrate according to inventive concepts described herein.

FIG. 7 shows an illustrative schematic demonstrating occlusion of uncovered substrate pores in a composite membrane having a graphene-based material sheet disposed upon a porous substrate according to inventive concepts described herein. In the illustrated embodiment, the substrate pores are tapered to facilitate occlusion and anchoring of the particle in the uncovered pore.

FIG. 8 shows an illustrative schematic demonstrating occlusion of uncovered substrate pores in a composite membrane having a graphene-based material sheet disposed upon a porous substrate according to inventive concepts described herein. The substrate pores are exemplified as tapered. In the illustrated embodiment, an initial particle occludes the pore and secondary particles of size smaller than the initial particle are introduced into the uncovered occluded pores to facilitate anchoring and ensure complete occlusion.

FIG. 9 shows an illustrative schematic demonstrating occlusion of uncovered pores in a composite membrane having a graphene-based material sheet disposed upon a porous substrate according to inventive concepts described herein. The substrate pores are exemplified as having a ledge or other form of narrowing at the pore exit to facilitate retention and anchoring of the particle in the uncovered pore. Such a ledge or other narrowing can for example be formed by deposition of a selected material to the backside of the substrate.

FIG. 10 shows an illustrative schematic demonstrating occlusion of uncovered substrate pores in a composite membrane having a graphene-based material sheet disposed upon a porous substrate according to inventive concepts described herein. Pores in the substrate are illustrated as being interconnecting and non-uniform in diameter. Pores are shown as occluded by introduction of a plurality of particles.

FIG. 11 shows an illustrative schematic demonstrating occlusion of uncovered substrate pores in a composite membrane having a graphene-based material sheet disposed upon a porous substrate including swellable particles according to inventive concepts described herein.

FIG. 12 shows an illustrative schematic demonstrating occlusion of uncovered substrate pores in a composite membrane having a graphene-based material sheet disposed upon a porous substrate according to inventive concepts described herein. In the illustrated embodiment, no occluding moiety needs to be introduced into the uncovered pore. The substrate material itself is swellable, on contact for example with an absorbable fluid. Swelling of the substrate material surrounding the uncovered pore results in occlusion of the pore.

FIG. 13 shows an illustrative schematic demonstrating occlusion of uncovered substrate pores in a composite membrane having a graphene-based material sheet disposed upon a porous substrate including an appropriate chemical reagent applied to initiate reaction between reactive groups on a particle and at a pore exit according to inventive concepts described herein.

FIGS. 14A and 14B show an illustrative schematic demonstrating occlusion of uncovered pores in a composite membrane having a graphene-based material sheet disposed upon a porous substrate wherein energy, such as light of selected wavelengths is applied to the back side of the composite membrane to facilitate anchoring of the particle in the uncovered pore according to inventive concepts described herein. FIG. 14B illustrates resultant anchoring of the particle in the substrate pore.

FIGS. 15A and 15B show an illustrative schematic demonstrating occlusion of uncovered pores in a composite membrane having a graphene-based material sheet disposed upon a porous substrate wherein energy is applied to the back side of the composite membrane to deform and conglomerate or active chemical reactions between particles and/or between particles and the pores surfaces or edges to facilitate anchoring of particle in the uncovered pore according to inventive concepts described herein. FIG. 15B illustrates resultant anchoring of the particle in the substrate pore

FIG. 16 shows an illustrative schematic showing steps in an exemplary uncovered pore occlusion process according to inventive concepts described herein.

FIG. 17 shows an illustrative schematic showing steps in another exemplary uncovered pore occlusion process according to inventive concepts described herein.

FIG. 18 shows an illustrative schematic showing steps in another exemplary uncovered pore occlusion process according to inventive concepts described herein.

FIG. 19 is an illustrative schematic demonstrating occlusion of uncovered pores by the process of FIG. 18 according to inventive concepts described herein. In the illustrated embodiment, the substrate pore is illustrated as having uniform diameter along its length. Shaped pores can also be employed. The illustrated embodiment shows the formation of a cured material or polymer within the uncovered pore to occlude the pore.

FIGS. 20A and 20B are SEM images illustrating latex bead healing (occlusion) of uncovered pores in a composite membrane according to inventive concepts described herein.

FIGS. 21A and 21B are SEM images illustrating the progress of latex bead healing (occlusion) of uncovered pores in a composite membrane according to inventive concepts described herein.

FIG. 22 is a graph of flow rate (μL/min) (left axis, diamonds) and cumulative permeate (right axis, squares) as a function of time through a composite membrane that is being subjected to uncovered substrate pore occlusion according to inventive concepts described herein. FIG. 23A is a SEM image showing occlusion of 1250 nm diameter pores in a silicon nitride substrate by a single graphene sheet according to inventive concepts described herein. FIG. 23B is a SEM image of occlusion of 1250 nm diameter pores in a silicon nitride substrate after subsequent application of a second sheet of graphene according to inventive concepts described herein.

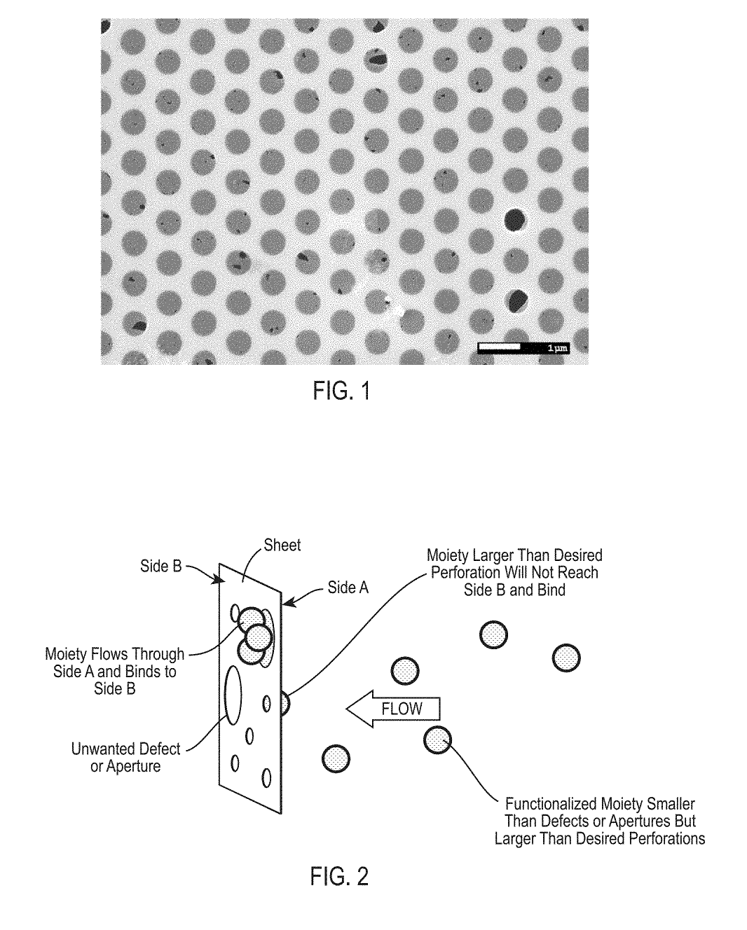

### DETAILED DESCRIPTION OF THE INVENTION

A variety of two-dimensional materials useful according to inventive concepts disclosed herein are known in the art. In various embodiments, the two-dimensional material comprises graphene, carbon nanomembranes (CNM), molybdenum disulfide, or boron nitride (specifically the hexagonal crystalline form of boron nitride). In an embodiment, the two-dimensional material is a graphene-based material. In more particular embodiments, the two-dimensional material is graphene. Graphene according to the embodiments of the present disclosure can include single-layer graphene, multi-layer graphene, or any combination thereof. Other nanomaterials having an extended two-dimensional molecular structure can also constitute the two-dimensional material in the various embodiments of the present disclosure. For example, molybdenum sulfide is a representative chalcogenide having a two-dimensional molecular structure, and other various chalcogenides can constitute the two-dimensional material in the embodiments of the present disclosure. Choice of a suitable two-dimensional material for a particular application can be determined by a number of factors, including the chemical and physical environment into which the graphene or other two-dimensional material is to be terminally deployed.

In an embodiment, the two dimensional material useful in membranes herein is a sheet of graphene-based material. Graphene-based materials include, but are not limited to, single layer graphene, multilayer graphene or interconnected single or multilayer graphene domains and combinations thereof. In an embodiment, graphene-based materials also include materials which have been formed by stacking independent single sheet or multilayer graphene sheets. In embodiments, multilayer graphene includes 2 to 20 layers, 2 to 10 layers or 2 to 5 layers. In embodiments, graphene is the dominant material in a graphene-based material. For example, a graphene-based material comprises at least 30% graphene by weight, or at least 40% graphene, or at least 50% graphene, or at least 60% graphene, or at least 70% graphene, or at least 80% graphene, or at least 90% graphene, or at least 95% graphene. In embodiments, a graphene-based material comprises a range of graphene content selected from 30% to 95%, or from 40% to 80% from 50% to 70%, from 60% to 95% or from 75% to 100%. In embodiments, a graphene-based material comprises a range of up to 35% oxygen by atomic ratio.

As used herein, a “domain” refers to a region of a material where atoms are uniformly ordered into a crystal lattice. A domain is uniform within its boundaries, but different from a neighboring region. For example, a single crystalline material has a single domain of ordered atoms. In an embodiment, at least some of the graphene domains are nanocrystals, having a domain size from 1 to 100 nm or 10-100 nm. In an embodiment, at least some of the graphene domains have a domain size greater than 100 nm to 1 micron, or from 200 nm to 800 nm, or from 300 nm to 500 nm. “Grain boundaries” formed by crystallographic defects at edges of each domain differentiate between neighboring crystal lattices. In some embodiments, a first crystal lattice may be rotated relative to a second crystal lattice, by rotation about an axis perpendicular to the plane of a sheet, such that the two lattices differ in “crystal lattice orientation”.

In an embodiment, the sheet of graphene-based material comprises a sheet of single or multilayer graphene or a combination thereof. In an embodiment, the sheet of graphene-based material is a sheet of single or multilayer graphene or a combination thereof. In another embodiment, the sheet of graphene-based material is a sheet comprising a plurality of interconnected single or multilayer graphene domains. In an embodiment, the interconnected domains are covalently bonded together to form the sheet. When the domains in a sheet differ in crystal lattice orientation, the sheet is polycrystalline.

In embodiments, the thickness of the sheet of graphene-based material is from 0.34 to 10 nm, from 0.34 to 5 nm, or from 0.34 to 3 nm. In an embodiment, a sheet of graphene-based material comprises intrinsic or native defects. Intrinsic or native defects are those resulting from preparation of the graphene-based material in contrast to perforations which are selectively introduced into a sheet of graphene-based material or a sheet of graphene. Such intrinsic or native defects include, but are not limited to, lattice anomalies, pores, tears, cracks or wrinkles. Lattice anomalies can include, but are not limited to, carbon rings with other than 6 members (e.g. 5, 7 or 9 membered rings), vacancies, interstitial defects (including incorporation of non- carbon atoms in the lattice), and grain boundaries.

In an embodiment, a sheet of graphene-based material optionally further comprises non-graphenic carbon-based material located on the surface of the sheet of graphene-based material. In an embodiment, the non-graphenic carbon-based material does not possess long range order and may be classified as amorphous. In embodiments, the non-graphenic carbon-based material further comprises elements other than carbon and/or hydrocarbons. Non-carbon elements which may be incorporated in the non-graphenic carbon include, but are not limited to, hydrogen, oxygen, silicon, nitrogen, copper and iron. In embodiments, the non-graphenic carbon-based material comprises hydrocarbons. In embodiments, carbon is the dominant material in non-graphenic carbon-based material. For example, a non-graphenic carbon-based material comprises at least 30% carbon by weight, or at least 40% carbon, or at least 50% carbon, or at least 60% carbon, or at least 70% carbon, or at least 80% carbon, or at least 90% carbon, or at least 95% carbon. In embodiments, a non-graphenic carbon-based material comprises a range of carbon selected from 30% to 95%, or from 40% to 80%, or from 50% to 70%.

Two-dimensional materials in which pores are intentionally created are referred to herein as “perforated,” such as “perforated graphene-based materials,” “perforated two-dimensional materials,” or “perforated graphene.” Two-dimensional materials are, most generally, those which have atomically thin thickness from single-layer sub-nanometer thickness to a few nanometers and which generally have a high surface area. Two-dimensional materials include metal chalogenides (e.g., transition metal dichalogenides), transition metal oxides, hexagonal boron nitride, graphene, silicene and germanene (see: Xu et al. (2013) “Graphene-like Two-Dimensional Materials) Chemical Reviews 113:3766-3798).

Two-dimensional materials include graphene, a graphene-based material, a transition metal dichalcogenide, molybdenum disulfide, a-boron nitride, silicene, germanene, or a combination thereof. Other nanomaterials having an extended two-dimensional, planar molecular structure can also constitute the two-dimensional material in the various embodiments of the present disclosure. For example, molybdenum disulfide is a representative chalcogenide having a two-dimensional molecular structure, and other various chalcogenides can constitute the two-dimensional material in embodiments of the present disclosure. In another example, two-dimensional boron nitride can constitute the two-dimensional material in an embodiment of the inventive concepts disclosed herein. Choice of a suitable two-dimensional material for a particular application can be determined by a number of factors, including the chemical and physical environment into which the graphene, graphene-based or other two-dimensional material is to be deployed.

The present disclosure is directed, in part, to sheets of graphene-based material or other two-dimensional materials containing a plurality of perforations therein, where the perforations have a selected size and chemistry, as well as pore geometry. In embodiments, the perforated graphene, perforated graphene-based materials and other perforated two-dimensional materials contain a plurality of size-selected perforations ranging from about 3 to 15 angstroms in size. In a further embodiment, the perforation size ranges from 3 to 10 angstroms or from 3 to 6 angstroms in size. The present disclosure is further directed, in part, to perforated graphene, perforated graphene-based materials and other perforated two-dimensional materials containing a plurality of size-selected perforations ranging from about 3 to 15 angstroms in size and having a narrow size distribution, including but not limited to a 1-10% deviation in size or a 1-20% deviation in size. In an embodiment, the characteristic dimension of the perforations is from about 3 to 15 angstroms in size.

The present disclosure is also directed, in part, to perforated graphene, perforated graphene-based materials and other perforated two-dimensional materials containing a plurality of perforations ranging from about 5 to about 1000 angstroms in size. In further embodiments, the perforations range from 10 to 100 angstroms, 10 to 50 angstroms, 10 to 20 angstroms or 5 to 20 angstroms. In a further embodiment, the perforation size ranges from 100 nm up to 1000 nm or from 100 nm to 500 nm. The present disclosure is further directed, in part, to perforated graphene, perforated graphene-based materials and other perforated two-dimensional materials containing a plurality of perforations ranging from about 5 to 1000 angstrom in size and having a narrow size distribution, including but not limited to a 1-10% deviation in size or a 1-20% deviation in size. In an embodiment, the characteristic dimension of the perforations is from 5 to 1000 angstrom.

For circular perforations or apertures, the characteristic dimension is the diameter of the perforation or aperture. In embodiments relevant to non-circular pores, the characteristic dimension can be taken as the largest distance spanning the perforation or aperture, the smallest distance spanning the perforation or aperture, the average of the largest and smallest distance spanning the perforation or aperture, or an equivalent diameter based on the in-plane area of the perforation or aperture. As used herein, perforated graphene-based materials include materials in which non-carbon atoms have been incorporated at the edges of the pores.

The present disclosure particularly describes methods directed to occluding apertures in a sheet of a graphene-based material or other two-dimensional material that are larger than a given threshold size, thereby reducing the plurality of apertures to a desired size and optionally with a specific chemistry. In embodiments, the reduced size of the aperture falls within the perforation and aperture size ranges given above. The threshold size can be chosen at will to meet the needs of a particular application. Perforations or apertures are sized as described herein to provide desired selective permeability of a species (atom, molecule, protein, virus, cell, etc.) for a given application. Selective permeability relates to the propensity of a porous material or a perforated two-dimensional material to allow passage (or transport) of one or more species more readily or faster than other species. Selective permeability allows separation of species which exhibit different passage or transport rates through perforations or apertures. In two-dimensional materials selective permeability correlates at least in part to the dimension or size (e.g., diameter) of perforations or apertures and the relative effective size of the species. Selective permeability of the perforations or apertures in two-dimensional materials such as graphene-based materials can also depend on functionalization of the perforation or aperture (if any) and the specific species that are to be separated. For electrically conductive two dimensional materials, selective permeability can be affected by application of a voltage bias to the membrane. Selective permeability of gases can also depend upon adsorption of a gas species on the filtration material, e.g., graphene. Adsorption at least in part can affect the local concentration of the gas species at the surface of the filtration material. Separation of two or more species in a mixture includes a change in the ratio(s) (weight or molar ratio) of the two or more species in the mixture after passage of the mixture through a perforated two-dimensional material.

The chemistry of the perforated apertures can be the same or different after being occluded according to the embodiments described herein. In various embodiments, occluding the apertures can involve occluding apertures within a particular size range such that no apertures remain within the size range, thereby conferred selectivity to the “healing” of the graphene-based material or other two-dimensional material. The embodiments of the healing processes described herein are applicable to both “through-holes” (i.e., pores in a single two-dimensional sheet) and “intralayer flow” (i.e., passages existing between stacked layers of individual single layer two-dimensional sheets or multiple layer sheets of 2-D material. Passages can include laterally offset pores within multiple two-dimensional sheets. Through-holes can also exist in multiple two-dimensional sheets when the pores are not substantially laterally offset from one another in the various layers

The embodiments described herein allow specific chemistries to be readily applied in a homogenous manner to graphene-based materials and other two-dimensional materials to allow for tunable activity across many applications. While the chemistries described herein can be applied homogenously to an entire surface of the sheet of graphene or other two-dimensional material, they generally provide specific activation of particular perforations or apertures of a given size using a carefully sized moiety that allows for aperture modification to take place. The described techniques can be advantageous in allowing the homogenous application of chemistry to the graphene-based material or other two-dimensional material surface while only occluding perforations or apertures of a certain desired size. The homogenous application of the various chemistries described herein can facilitate scalable production and manufacturing ease. Perforation or aperture modification can confer a specific chemistry to the perforations or apertures (e.g., functional selectivity, hydrophobicity, and the like) and allow for at least partial occlusion of the perforations or apertures to take place in various embodiments. Such selective modification of the apertures can allow selective separations to take place using the graphene-based material, including size-based separations.

For example, perforations or apertures can be selectively modified by various known methods to contain hydrophobic moieties, hydrophilic moieties, ionic moieties, polar moieties, reactive chemical groups, for example, amine-reactive groups (chemical species that react with amines) carboxylate-reactive groups (chemical species that react with carboxylates), amines or carboxylates (among many others), polymers and various biological molecules, including for example, amino acids, peptide, polypeptides, enzymes or other proteins, carbohydrates and various nucleic acids.

Furthermore, the techniques described herein can be configured to at least partially occlude large apertures within the sheet of graphene-based material or other two-dimensional material in preference to smaller apertures, thereby allowing the smaller apertures to remain open and allow flow to be maintained therethrough. This type of selective flow can allow molecular sieving to take place using the graphene-based material or other two-dimensional material, rather than the solution-diffusion model provided by current polymeric solutions. In some aspects, apertures or defects are blocked to provide flow reduction or blockage within a range of 50% or more, 60% or more, 70% or more, 80% or more, 90% or more, 95% or more. In further aspects, however, all the apertures and/or defects in a graphene-based material or other two-dimensional material can be occluded in order to substantially block passage or flow, herein 99% or more through the two-dimensional material or block passage or flow through the two-dimensional material entirely. In an embodiment, a graphene-based material or other two-dimensional material that is occluded in order to substantially or entirely block passage or flow through the material can be used as a starting material for forming a size-selected perforated two-dimensional material. Size-selected perforations can be introduced into the substantially or entirely blocked two-dimensional material employing art known methods for generating perforations of a selected size and, if any, a selected functionalization.

Although the description herein is primarily directed to graphene-based materials, it is to be recognized that other two-dimensional materials or near two-dimensional materials can be treated in a like manner. The at least partially occluded graphene-based materials prepared according to the techniques described herein can be used for occluding fluid flow, particularly liquid or gas flow for separations, including filtration membranes and filtration systems. In addition, they can be used in optical or electronic applications.

In some embodiments, the graphene-based material can be transferred from its growth substrate to a porous substrate in the course of, before or after practicing the embodiments described herein.

By way of example, a sheet of a graphene-based material or sheet of another two-dimensional material can have a plurality of perforations therein, and a direction of fluid flow therethrough can establish an “upstream” side (alternative the top surface) and a “downstream” side (alternatively the bottom surface) of the sheet. The downstream side of the sheet of the graphene-based material or sheet of another two-dimensional material can be next to or in contact with a substrate, such as a porous substrate. In some embodiments, the substrate can provide support to the sheet of the graphene-based material while practicing the various techniques described herein. The perforations in the sheet of a graphene-based material or sheet of another two-dimensional material can be intentionally placed therein, or they can occur natively during its synthesis. According to the embodiments of the present disclosure, the perforations can have a distribution of sizes, which can be known or unknown. By placing an occluding moiety within a flow contacting the graphene-based material or other two-dimensional material, apertures having a desired size profile can become occluded according to the embodiments described herein.

In some embodiments described herein, a fluid containing a sized moiety can be flowed through the sheet of graphene-based material or other two-dimensional material. The sized moiety can lodge in some of the apertures in the sheet and induce occlusion of at least the portion of the apertures in the sheet in which the sized moiety lodges. In other embodiments, a sized moiety can occlude fluid flow on the sheet of graphene-based material or other two-dimensional material from the upstream side of the graphene. Various embodiments of these various flow configurations are described below.

Occluding at least a portion of the apertures in the foregoing manner can result in reducing the size and number of apertures, possibly modifying a flow path and making the graphene-based material or other two-dimensional material suitable for use in an intended application. For example, the graphene-based material or sheet of another two-dimensional material can be processed in the foregoing manner to produce a cutoff pore size in a molecular filter. Depending on the nature of the moiety in the flow path, the moiety can be covalently or non-covalently attached to the graphene-based material, or mechanically connected to the graphene-based material.

In some embodiments, the “downstream” side of the sheet of graphene-based material can be “primed” or functionalized with oxygen via plasma oxidation or the like, such that the graphene-based material can be reactive with a moiety passing through the apertures. In some embodiments, the moiety in the flow path can bind to functional groups introduced to the graphene-based material, such that the moiety binds to the graphene-based material and the apertures become at least partially occluded. Suitable binding motifs can include, but are not limited to, addition chemistry, crosslinking, covalent bonding, condensation reactions, esterification, or polymerization. In various embodiments, the occluding moiety can be sized to reflect a particular cutoff regime, such that it only passes through apertures having a certain threshold size or shape. For example, in various embodiments, the occluding moieties can be a substantially flat molecule or spherical in shape. POSS® silicones (polyhedral oligomeric silsesquioxanes), for example, represent one particular type of occluding moiety that can be made at a very specific size and functionalized to tether to oxygenated functionalization on the apertures. Other examples, of useful occluding moieties include fullerenes, dendrites, dextran, micelles or other lipid aggregates, and micro-gel particles. Some or all of these techniques may be applied to other two-dimensional materials as well.

In various embodiments, the graphene-based material can be perforated and functionalized with oxygen, such as treating the graphene-based material with oxygen or a dilute oxygen plasma, thereby functionalizing the graphene-based material with oxygen moieties. In some embodiments, the graphene based material can be functionalized in this manner while on a copper substrate. Subsequently, the oxygen functionalities can be reacted via a chemistry that converts the oxygenated functionalities into a leaving group (such as a halide group, particularly a fluoro group, or sulfonic acid analogs, such as tosylates, triflates, mesylates, and the like). This chemistry results in sites on the substrate that are vulnerable to nucleophilic attack and can be used for additional chemistry, as detailed above, or allowing the graphene based material to bind to the substrate. In some embodiments, the graphene-based material can functionalized with oxygen so as to provide graphene oxide platelet membranes.

FIG. 2 shows an illustrative schematic demonstrating how a graphene sheet or sheet of another two-dimensional material can undergo backside functionalization according to the embodiments described herein to occlude undesired apertures or defects in the sheet. In the drawings, Side A refers to the side of the graphene or other two-dimensional material being exposed to the upstream flow and Side B refers to the backside of the graphene or other two-dimensional material not exposed to the flow. In certain embodiments, the flow may be across the two dimensional material instead of merely through. The backside of the sheet may be primed or activated to react with the occluding moieties. In an embodiments, the backside of the sheet is functionalized to bind or react with occluding moieties. As shown in FIG. 2, the occluding moieties do not pass through aperture or defects having a size too small for the occluding moieties to pass through, but the occluding moieties do pass through the larger undesirable apertures or defects. On passage through the undesired apertures or defects, the occluding moieties react and/or bind at the aperture or defect and occlude the aperture or defect. The flow is sufficiently high that diffusion of occluding moieties on the backside of the sheet away from the aperture that they exit is minimized to avoid occlusion of the smaller apertures or defects. While the aforementioned chemistry provides a technique for backside attack, it should also be recognized that a sheet of graphene or other two-dimensional material can also be functionalized or primed such that it can undergo front side attack, particularly in cases where transfer is less desirable during the processing of a product. Front side attack can ensure retention of configuration. Front side attack can occur similarly to the methods depicted in FIG. 2, with the exception that bonding occurs on the upstream or Side A of the graphene sheet or sheet of other two-dimensional material and there may be less selectivity in bonding holes of a desired size over larger apertures. In an embodiment, methods to permit front side attack on the surface of a graphene-based material again begin with an oxygen functional group on the surface of the graphene-based material, which are treated with an agent such as pyridine, triflate, or analogs thereof to provide a good leaving group. Subsequent chemistry can be conducted to remove the copper growth substrate and use additional chemistry to occlude holes or apertures below the diameter which the moiety may pass. Note that both front side and back side approaches allow for a homogenous application of chemistries, which can be desirable for scalability.

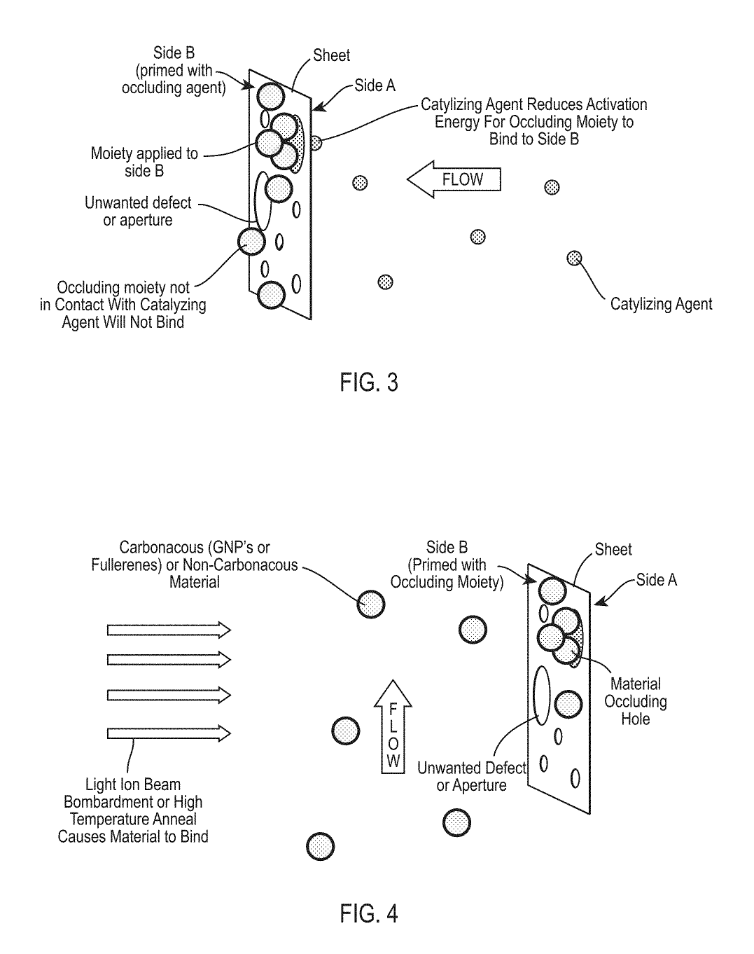

In other embodiments, the downstream side of the graphene-based material or other two-dimensional material can be primed with an occluding substance and a moiety that catalyzes the reaction of the occluding substance with the graphene or other two-dimensional material can pass through the apertures. Thus, in this case, the moiety does not become bonded to the graphene or other two-dimensional material itself. FIG. 3 shows an illustrative schematic demonstrating how a perforated graphene sheet or sheet of another two-dimensional material can undergo occlusion by flowing a catalyst therethrough. In more particular embodiments, the methods can include treating the graphene or graphene-based material with lithium and an appropriate charge transfer catalyst in order to create polyethylene glycol chains around the periphery of the graphene perforations. In some embodiments, such a reaction scheme can be conducted under substantially anhydrous conditions. In some embodiments, the moiety in the flow can catalyze the reaction with a polymer substrate (e.g., upon which the graphene-based material or other two-dimensional material is placed following transfer from its growth substrate), which can be considered a subset of the foregoing embodiments.

In the foregoing embodiments, also depicted in FIGS. 2 and 3, priming the graphene-based material can involve casting a porous substrate, such as a polymer substrate, onto the graphene-based material when it is on its copper growth substrate. The copper can then be etched away. Thereafter, the porous substrate can be exposed to light or some other form of electromagnetic radiation to cause a change in the substance, thereby making it no longer permeable. In alternative embodiments, the porous substrate can be exposed to a compound that binds to the porous substrate. In still other alternative embodiments, the porous substrate can maintain its porosity when practicing the embodiments described herein.

In still further embodiments, carbonaceous or non-carbonaceous materials can be flowed over the graphene based material or other two-dimensional material and become tethered to the open apertures. Suitable materials can include, for example, graphene nanoplatelets (GNPs), fullerenes of various sizes, boron nitride, or carbon nanotubes. In more particular embodiments, tethering of the carbonaceous or non-carbonaceous material can be accomplished by utilizing a light or gentle ion beam, a high temperature annealing step, exposing to light to generate a photo-active reaction. The high temperature annealing step could comprise isocyanate crosslink chemistry. In some embodiments, flow through the two-dimensional material can become completely blocked. In some embodiments, smaller apertures can remain open. FIG. 4 shows an illustrative schematic demonstrating how a perforated graphene sheet or sheet of another two-dimensional material can undergo occlusion with a carbonaceous material or a non-carbonaceous material in the presence of a light ion beam or a high temperature annealing step.

In the depicted embodiments, the carbonaceous or non-carbonaceous materials are flowed laterally across the sheet of graphene-based material or other two-dimensional material, rather than passing through the apertures. In alternative embodiments, the carbonaceous materials or non-carbonaceous materials can be flowed through the sheet of graphene-based material or other two-dimensional material.

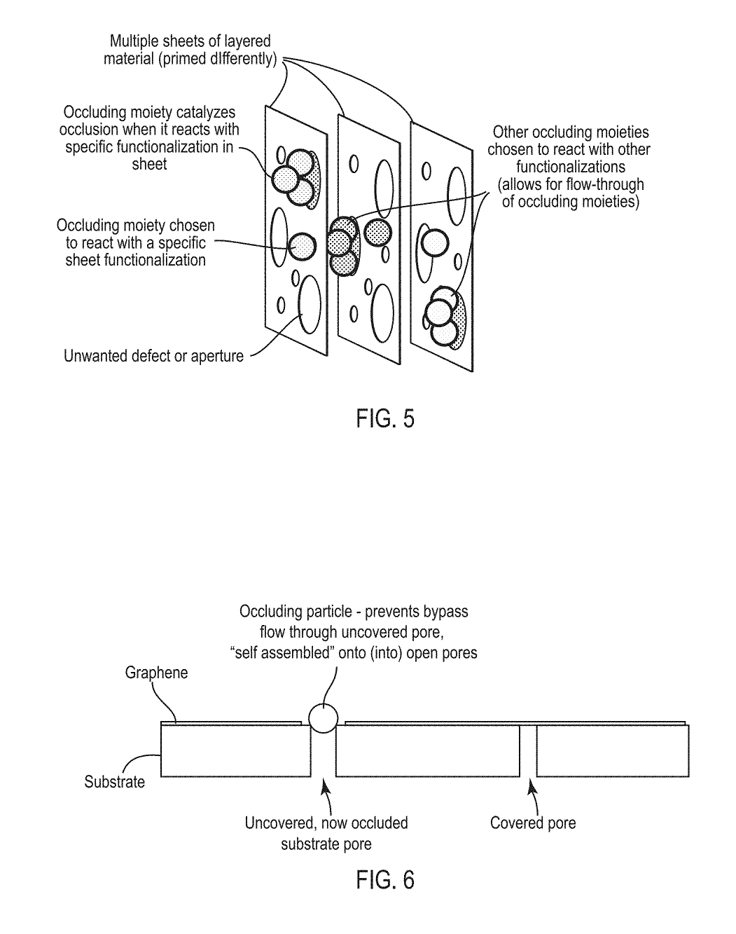

In still other embodiments, functionalization or activation of multiple, potentially different layered sheets of graphene-based materials or other two-dimensional material (e.g. complementary chemistries) can be leveraged to allow for flow not only through channels, but also via intralayer flow. Healing or partial occlusion can result from further modification of apertures. That is, layered sheets of two-dimensional material can be differentially functionalized according to the embodiments described herein. FIG. 3 shows an illustrative schematic demonstrating how a perforated graphene sheet or sheet of another two-dimensional material can undergo occlusion by flowing a catalyst there through. FIG. 4 shows an illustrative schematic demonstrating how a perforated graphene sheet or sheet of another two-dimensional material can undergo occlusion with a carbonaceous material or a non-carbonaceous material in the presence of a light ion beam, or a high temperature annealing step. FIG. 5 shows an illustrative schematic demonstrating how apertures in multiple layered graphene sheets or sheets of other two-dimensional materials can become differentially occluded. In some embodiments, the functionalization can be chosen such that apertures of different sizes are occluded in the various graphene sheets.

The present disclosure is directed, in part, to composite membranes formed from a porous substrate having a plurality of pores with a sheet of two-dimensional material disposed on the surface of the porous substrate and defining a top surface of the composite membrane. A portion of the pores of the substrate are covered by the two-dimensional material and a portion of the pores of the substrate are not covered by the two-dimensional material due, for example, to defects formed during synthesis of the two-dimensional material, formed during handling of the two-dimensional material, or formed when the two-dimensional material is disposed on the porous substrate. Defects or apertures in the two-dimensional material can result in undesired passage of species through the composite membrane. It is desired for use in filtration applications, that substantially all of the substrate pores are covered by the two-dimensional material so that passage through the membrane is primarily controlled by passage through the two-dimensional material. In a specific embodiment, substantially all pores of the substrate are covered by a two-dimensional material that contains perforations of a desired size range for selective passage through the membrane. In a specific embodiment, perforations in the two-dimensional material have a selected chemistry at the perforation as discussed above. The perforation in the two-dimensional material can have selected size or selected size range and discussed above. In a specific embodiment, the two-dimensional material is a graphene-based material. In a specific embodiment, the two-dimensional material is a graphene-based material which comprises single-layer graphene or multi-layer graphene.

The disclosure provides methods for occluding uncovered substrate pores in the composite membrane as described above. In an embodiment, the method includes introducing one or more occluding moieties at least partially into at least one uncovered pore to occlude the at least one uncovered pore. In specific embodiments, 50% or more of the uncovered substrate pores are occluded. In more specific embodiments, 60% or more, 75% or more, 80% or more, 90% or more, 95% or more or 99% or more of the uncovered substrate pores are occluded. In specific embodiments, occlusion of uncovered pores reduced flow through the composite membrane (compared to the non-occlude membrane) by 50% or more. In specific embodiments, occlusion of uncovered pores reduced flow through the composite membrane (compared to the non-occluded membrane) by 60% or more, 75% or more, 80% or more, 90% or more, 95% or more or 99% or more.

The extent of occlusion of uncovered pores can be assessed by various methods. Detection of uncovered pores can, for example, be assessed using a selected assay fluid, e.g., a detectible gas, such as SF₆, to detect the location (or approximate location) of uncovered pores by passage of the assay fluid. Uncovered pores may be detected by use of the passage of detectible chemical species, particles, electrons, UV or visible light through the pores. The presence of uncovered pores can also be detected by various imaging methods. The presence and or location (or approximate location) of pores can be assessed using various imaging methods (including scanning electron microscopy, scanning probe microscopy, scanning tunneling microscopy, atomic force microscopy, transmission electron microscopy, x-ray spectroscopy, etc.); detecting analyte, particles or ions passing through pores (using mass spectrometry, secondary mass spectrometry, Raman spectroscopy, residual gas analysis, detecting Auger electrons, detecting nanoparticles using a microbalance, detecting charged species with a Faraday cup, detecting secondary electrons, detecting movement of analyte through defects, employing an analyte detector, identifying a composition, mass, average radius, charge or size of an analyte; detecting electromagnetic radiation passing through defects; detecting electromagnetic radiation given off by analyte; and detecting electromagnetic radiation or particles back scattered from the membrane.

Uncovered substrate pores include those pores that are only partially covered, but through which non-selective passage can occur.

The porous substrate of the composite membrane can be any porous material compatible with a disposed two-dimensional material and particularly with a graphene-based material. The porous substrate is selected to be compatible with the application for which the composite membrane is intended. For example, compatible with the gases, liquids or other components which are to be in contact with the composite membrane. The porous substrate provides mechanical support for the two-dimensional material and must maintain this support during use. The porous support should substantially retain pores that are covered with two-dimensional material. In specific embodiments, the porous material is made of a polymer, metal, glass or a ceramic

The pores in the substrate can have uniform pore diameter along the length of the pore, or they can have a diameter that varies along this length. Pores or pore openings (entrance or exit) can be shaped, as discussed below, to facilitate retention of occluding moieties in uncovered pores. Pores may be tapered, ridged or provided with one or more ledges to facilitate retention of occluding moieties in uncovered pores. In a specific embodiment, the pore entrance and/or the pore exit is narrowed compared to the rest of the pore to facilitate retention of occluding moieties. In some embodiments, pores in the substrate are preferably of uniform size and uniform density (e.g., uniformly spaced along the substrate). In some embodiments, pores may be independent or may be interconnected with other pores (tortuous). In embodiments, pores sizes (e.g. diameters) can range from 10 nm to 10 microns or more preferably from 50 nm to 500 nm. For methods and composite membranes herein a top surface of the membrane is defined as the surface upon which the two-dimensional material is disposed. One surface contains pore entrance openings and the second surface contains pore exit openings. Introduction of occluding moieties is through pore entry openings so that introduction of such moieties is selectively into pores that are not covered by two-dimension materials. Pore entrance and exits are defined by flow direction through pores.

Occluding moieties most generally include any material that can be selectively introduced into uncovered pores and retained therein to occlude the pore. A step of chemical reaction, application of energy in the form of heat, electromagnetic radiation (e.g., UV, visible or microwave irradiation), or contact with an absorbable material can be applied to deform, swell, polymerize, cross-link or otherwise facilitate retention of occluding materials in a pore. In an embodiment, the occluding materials are one or more particles sized for entrance at least in part into an uncovered pore. Particle size and pore shape may be selected to facilitate retention in the uncovered pores. Particles may be deformable, for example, by application of pressure, heat, microwave radiation or light of a selected wavelength (e.g. UV light), or by ion bombardment. Deformable particles introduced into pores are retained in pores after deformation. Particles may be swellable, where the size of a particle increases on contact with an absorbable material which induces swelling. The absorbable material can, for example, be a fluid including liquids or gases, water or an aqueous solution or a miscible mixture of water and an organic solvent, a polar organic solvent or a non-polar organic solvent. The swellable particle and the absorbable fluid are selected to achieve a desired level of swelling to achieve retention in the pore.

Occluding particles can be made of any suitable material. In specific embodiments, particles selected from metal particles, silica particles, particles of metal oxide, or polymer particles. In specific embodiments, particles are made of melamine, polystyrene or polymethyl methacrylate (PMMA). In a specific embodiment, the particles are made of latex (polystyrene). In specific embodiments, the substrate pore occluding particles are themselves permeable to provide a selective permeability through the occluded pores. In specific embodiments, the substrate pore occluding particles are permeable to fluid flow and provide for separation of components in the fluid. Permeable materials could include hydrogels, polymers, proteins, zeolites, metal-organic framework materials, or thin film solution membranes.

Particle size is generally selected based on the pores sizes present in the substrate so that the particle can enter the pore and be retained in the pore. Particles may be monodisperse if the pore entrance openings are uniform in size. A mixture of particles of different sizes can be employed when pore openings are non-uniform in size. A mixture of particles of different sizes (having a selected particle size distribution or being polydisperse in size) can be used, if pores with different (or unknown sizes) are present in the substrate. In an embodiment, the occluding particle is selected to have particle size that is approximately the same size as a pore entrance opening. The occluding particle may be slightly larger for tapered pores and slightly smaller for non-tapered pores such that the pores have a larger cross-section on the side of the substrate exposed to upstream flow. In an embodiment, particles are sized for at least partial introduction into an uncovered pore, but wherein the particle cannot exit the uncovered pore. Exit from the pore can be inhibited or prevented by providing shaped pores in which the pores are narrowed at some point along its length. Particles useful in the methods herein will in an embodiment range in size from 10 nm to 10 microns.

In an embodiment, employing deformable or swellable particles, the respective particles are deformed or swollen after introduction to an uncovered pore.

In an embodiment occlusion may be facilitated through controlled fouling, where a fluid is flowed to the composite membrane surface, and material from the fluid is bonded to composite membrane pores that are defective. The fouling may be controlled such that it blocks non-selective pores.
In an embodiment occlusion may be facilitated through healing with particles in air or gas. Particles are aerosolized and/or suspended in air and then forced through the membrane, such as by having convective flow of the air through the membrane. The convective flow of the air could be facilitated by applying a pressure differential across the membrane. The particles could be those described herein, with the methods described herein for fixing the particles to the membrane.

In an embodiment, occluding particles carry one or more chemical reactive groups for reaction with compatible reactive groups in the at least one uncovered pore, on the surface of the substrate at the uncovered pore or on other particles to facilitate anchoring of at least one particle in at least one uncovered pore. The particles can carry any one or more of a reactive chemical species, for example, the reactive species may be an amine, a carboxylate acid, an activated ester, a thiol, an aldehyde or a hydroxyl group. Particles useful in the inventive concepts disclosed herein which carry reactive groups can be prepared by known methods or may be obtained from commercial sources. Reactive groups on the particles can react with compatible reactive groups on the surface of the substrate at an uncovered pore, within the pore or at pore openings to facilitate retention in the pore. In an embodiment, particles may react with other particles in the pore to facilitate retention in the pore. One of ordinary skill in the art can employ a variety of chemically reactive groups to facilitate reaction with a pore to facilitate retention and anchoring in the pore. It will be appreciated that chemical reaction between particles, between particles and the pore surface, edges, openings or exits can be activated or induced by introduction of a reactive species, reagent or catalyst into a pore containing at least one occluding particle. It will also be appreciated that a chemical reaction between particles, between particles and the pore surface, edges, openings or exits can be activated or induced, for example, by heating, microwave irradiation, irradiation with light of selective wavelength (e.g., UV radiation) or by application of an ion beam, or by any method known in the art that is compatible with the materials employed.

In an embodiment, the occluding moieties are selected from one or more monomers, oligomers, uncured polymers or uncross-linked polymers. These occluding moieties are introduced selectively into uncovered pores and wherein the monomers, oligomers or polymers are polymerized, cured or cross-linked after they are introduced into the at least one uncovered pore. Polymerization can be effected for example by introduction of a polymerization catalyst, heating, microwave irradiation, or irradiation with light of a selected wavelength or by any method known in the art that is compatible with the materials employed. Curing of an uncured polymer or cross-linking of a polymer can be effected by any art-known method, for example by introduction of a curing or cross-linking reagent or application of heating, microwave irradiation, or irradiation with light of a selected wavelength or by any method known in the art that is compatible with the materials employed.

In an embodiment, the occlusion method further comprising a second step of introducing secondary particles into the at least one uncovered pore having a first particle therein occluding the uncovered pore, where the secondary particles are sized to be smaller than the first particle. In this embodiment, the initial particle and the secondary particles may be deformable or swellable as described above and may be deformed or swollen after introduction of the secondary particles. The initial particle and the secondary particles may carry one or more reactive groups as described above for chemical reaction of particles in the pores to facilitate retention in the pore.

In an embodiment, the composite membrane further comprises a coating layer on the top surface of the porous substrate between that surface and the sheet of two-dimensional material. Chemical reaction of a particle or other occluding moiety with reactive species on this coating at the entrance of the uncovered pore can facilitate anchoring and retention in the pore.

Occluding moieties are introduced to the top surface of the composite membrane where the occluding moieties can enter uncovered substrate pores. Introduction can be by any appropriate method and preferably is by application of a flow of fluid containing a selected concentration of occluding moieties. In a specific embodiment, the fluid is an aqueous solution carrying a selected concentration of occluding moieties. The concentration of occluding moieties in the flow introduced can be readily optimized empirically to optimize the effectiveness or efficiency of occlusion. Effectiveness or efficiency of occlusion can be assessed by measurement of the flow rate through the composite membrane, by accumulation rate of permeate or by an assessment of the selectivity of flow. A decreasing flow rate or a leveling off of permeate accumulation indicates successful occlusion. In an embodiment, the flow of occluding moieties includes a surfactant to decrease or minimize clumping or aggregation of occluding moieties and to facilitate entry of occluding moieties into uncovered pores. The inclusion of an appropriate surfactant is particularly beneficial for the introduction of occluding particles. In a specific embodiment, the surfactant is a non-ionic surfactant, such as (polyethylene glycol sorbitan monooleate). One of ordinary skill in the art can readily select a surfactant appropriate for the methods herein.

In a preferred embodiment, introduction of occluding moieties to the top surface of the composite membrane is by application of a cross-flow to the surface. The velocity of the cross-flow can be varied according to desired results. According to an embodiment, the pressure and flow may be varied as desired. In an embodiment, the shear velocity of the flow may be controlled. In an embodiment, the pressure across the composite membrane may be stopped while shear flowing. In an embodiment, the pressure on both sides of the membrane may be equalized. In an embodiment, the pressure may be controlled in cycles to alternately provide flow forward and then backward. The pressure on one or both sides of the membrane may be pulsed. Further, peristaltic pump rate and dimensions of the channel through the composite membrane may be controlled according to embodiments.

In an embodiment, the pore occlusion method further comprising a step of cleaning the top surface after introduction of occluding moieties into uncovered pores to remove occluding moieties that have not entered uncovered pores. This cleaning step can comprise flow of an appropriate fluid (gas or liquid) to or across the top surface of the membrane. In a specific embodiment, a flow of water or an aqueous solution is applied to or across the top surface of the membrane. In a specific embodiment, the aqueous solution contains a surfactant (as discussed above) to decrease clumping or aggregation of particles on the top surface.

In an embodiment, the introduction and cleaning steps as well any intervening steps to facilitate retention of particles in uncovered pores (e.g., deformation, chemical reaction, swelling or application of energy) are repeated until additional occlusion of pores ends or until a selected level of uncovered pore occlusion is achieved. As discussed above, various methods for accessing the extent or efficiency of pore occlusion can be employed.

In an embodiment, cycles of introduction and cleaning can be repeated until at least 80% of the uncovered pores are occluded. In an embodiment, cycles of introduction and cleaning can be repeated until at least 95% of the uncovered pores are occluded. In an embodiment, cycles of introduction and cleaning can be repeated until at least 99% of the uncovered pores are occluded.

In preferred embodiments, the two-dimensional material is a graphene-based material. In preferred embodiments, the two-dimensional materials is a sheet of graphene containing single layer graphene, few layer graphene (having 2-20 layers) or multilayer graphene.

In an embodiment, the pore occlusion method can be practiced without introducing an occluding moiety into uncovered pores. In this embodiment, a composite membrane as discussed above is provided wherein a sheet of two-dimensional material covers at least a portion of the pores of the substrate; but wherein at least one pore of the substrate is not covered by the two-dimensional material. In this embodiment, the substrate material forming the pores comprises a swellable material. The substrate itself may be made of a swellable material or more preferably the substrate material surrounding the pores is formed of a swellable material. For example, a coating of swellable material can be applied to the inside surfaces of the substrate pores. Selective introduction of an absorbable material into the uncovered pores results in local swelling of the swellable material surrounding the uncovered pore and occlusion of the uncovered pore. In an embodiment, the uncovered pores are selectively contacted with an absorbable fluid.

The disclosure further provides a composite membrane comprising a porous substrate having a plurality of pores and a sheet of two-dimensional material disposed on a surface of the porous substrate and defining a top surface of the membrane, wherein the sheet of two-dimensional material covers at least a portion of the pores of the substrate, wherein at least one pore of the substrate is not covered by the two-dimensional material and wherein at least one uncovered pore of the substrate is occluded with an occluding moiety. In an embodiment, the composite membrane has at least one uncovered pore occluded with one or more particles or occluded with a polymer, cured polymer or cross-linked polymer formed in the at least one uncovered pore.

FIG. 6 schematically illustrates occlusion of uncovered pores in the substrate of a composite membrane having a graphene-based material sheet disposed upon a porous substrate forming a top surface thereof. The occluding moiety is illustrated as a particle. A particle, size-selected based on pore size, to at least partially enter an uncovered pore is illustrated. As discussed herein a plurality of particles are introduced to the top surface of the membrane and a portion of the particles enter and are retained in the uncovered pores. A particle enters at least one uncovered pore and occludes the pore preventing passage though the occluded pore. The substrate may be pre-wetted in some embodiments.

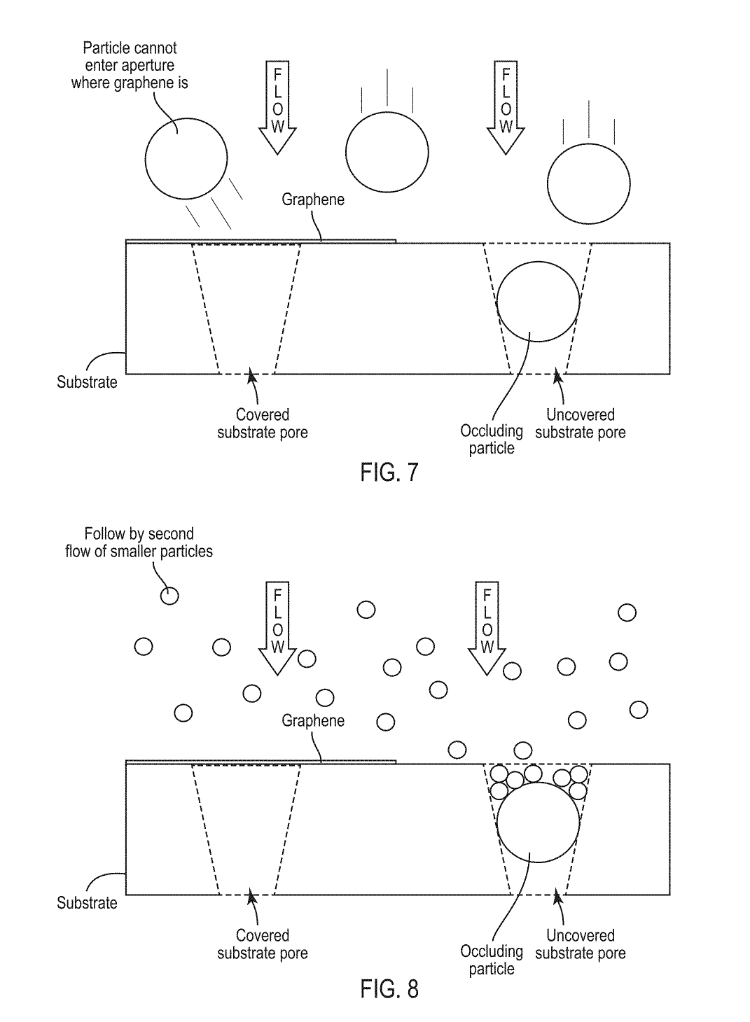

FIG. 7 schematically illustrates an exemplary occlusion method applied to a composite membrane having a graphene-based material sheet disposed upon a porous substrate where the substrate pores of the membrane are tapered such that the pores have a larger cross-section on the side of the substrate exposed to upstream flow to facilitate retention of the occluding material and anchoring of the occluding material in the uncovered pore. This embodiment is exemplified with an occluding particle which is size-selected to enter an uncovered pore and is inhibited or prevented from exiting the pore by tapering of the pore. It will be appreciated the substrate pores can be variously shaped to facilitate retention of occluding moieties, particularly particles. The direction of particle flow is illustrated as perpendicular to the membrane top surface. It will be appreciated that cross-flow parallel to the top surface can be applied to introduce occluding moieties to the top surface.

FIG. 8 schematically illustrates another exemplary occlusion method where the composite membrane has a graphene-based material sheet disposed upon a porous substrate where the substrate pores are tapered to facilitate retention of the occluding material and anchoring of the occluding material in the uncovered pore. In the illustrated embodiment, an initial particle is introduced into the uncovered pore to occlude the pore and secondary particles of size smaller than the initial particle are introduced into the uncovered occluded pores to facilitate anchoring.

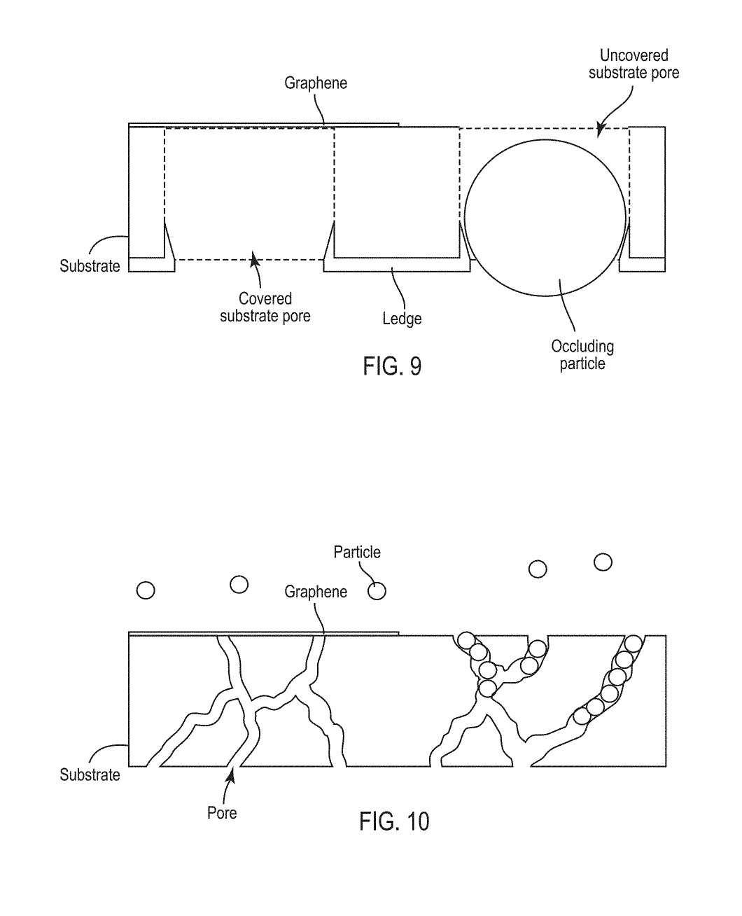

FIG. 9 schematically illustrates another exemplary occlusion method applied to composite membranes having a graphene-based material sheet disposed upon a porous substrate. The substrate pores are exemplified as having a ledge or other form of narrowing along their length and specifically at the pore exit to facilitate retention and anchoring of an occluding moiety (exemplified as a particle) in the uncovered pore. In an embodiment, the particle may be inserted into the pore, and then a ridge may be formed after the particle is inserted.

FIG. 10 schematically illustrates another exemplary occlusion of uncovered substrate pores in a composite membrane having a graphene-based material sheet disposed upon the porous substrate. Pores in the substrate are illustrated as being partially interconnected and non-uniform in diameter, and may form a tortuous path through the substrate. Pores are shown as occluded by introduction of a plurality of particles. It is to be noted that if pore connections exist between covered and uncovered pores that occlusion of uncovered pores may reduce desired flow through covered pores.

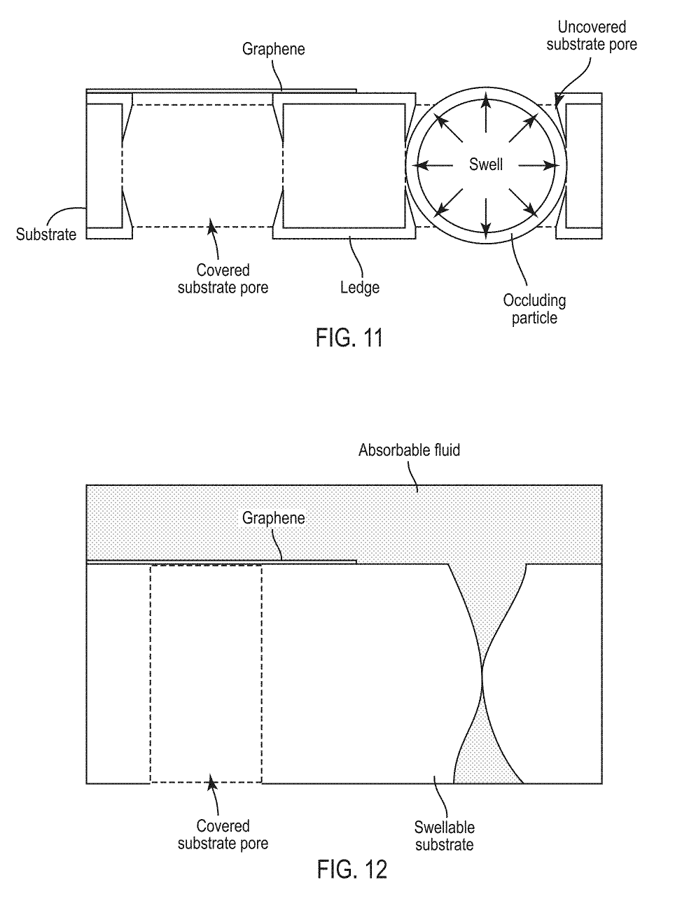

FIG. 11 schematically illustrates another exemplary occlusion of uncovered pores in a composite membrane having a graphene-based material sheet disposed upon a porous substrate. The substrate pores are illustrated as having a ledge or other form of narrowing at both the entrance and exit from the pores. In the illustrated embodiment, the particle is swellable, such that the non-swollen particle is of a size that will enter the uncovered pore, but which on swelling is of a size that will not exit the uncovered pore. In specific embodiments, the swellable particle is composed at least in part of a swellable polymer. More specifically, the swellable particle is composed at least in part of a swellable amorphous polymer. In specific embodiments, the swellable particle is composed at least in part of a hydrogel. Swelling ratios of swellable polymers and hydrogel can be adjusted by variation of composition of the polymer or hydrogel as is known in the art. Swelling can for example be initiated on contact with an absorbable fluid, such as water or an organic solvent. For example, a hydrogel can be swollen employing absorption of water or aqueous solution. For example, a non-polar or hydrophobic polymer can be swollen with a hydrocarbon solvent. For example, a polar or hydrophilic polymer can be swollen with water or alcohol or mixtures thereof.

In embodiments illustrated in FIGS. 6-11, occluding particles can optionally be provided with one or more reactive groups as discussed above which can react or can be activated to react with compatible chemical moieties in the pores, at the edges of the pores, at the substrate surface at the pore opening or pore exit or disposed on ledges or other structures within the pores. Such chemical reactions facilitate anchoring of the particle in the pore. In an embodiment, occluding particles can be provided with compatible reactive chemical groups for reactions between particles in a pore.

FIG. 12 schematically illustrates another exemplary occlusion of uncovered pores in a composite membrane having a graphene-based material sheet disposed upon a porous substrate. In the illustrated embodiment, no occluding moiety is introduced into the uncovered pore. The substrate material itself is swellable, on contact for example with an absorbable fluid. Swelling of the substrate material surrounding the uncovered pore results in occlusion of the pore. In a related embodiment, the substrate is not made entirely of a swellable material, but the inside surface of the pores of the substrate are provided with a coating that is swellable.

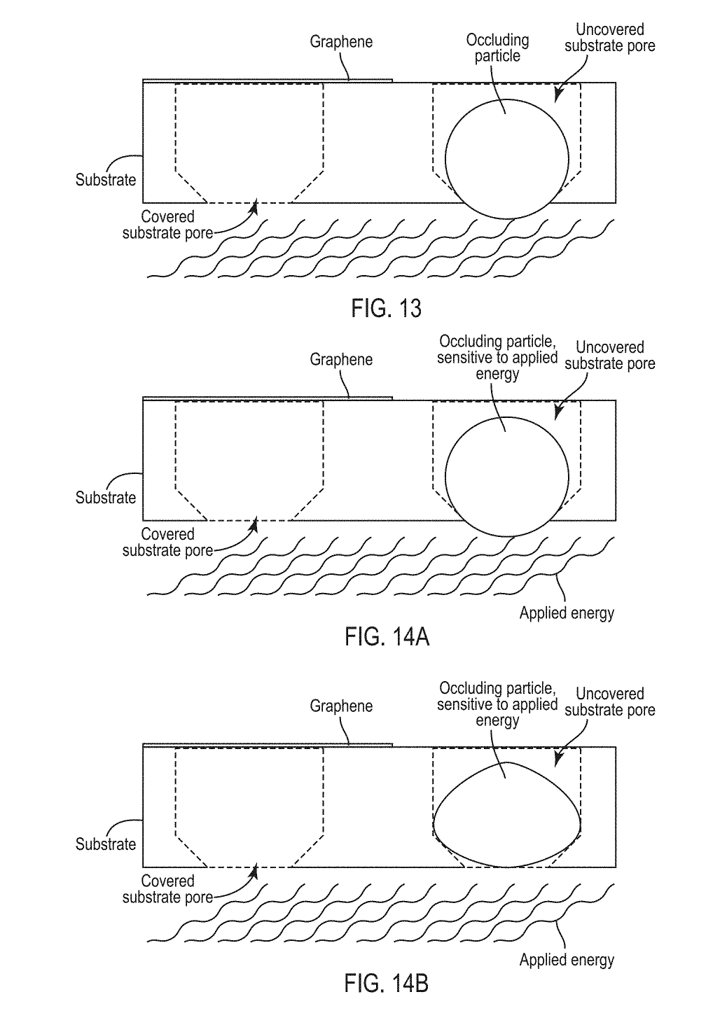

FIG. 13 schematically illustrates another exemplary occlusion of uncovered pores in a composite membrane having a graphene-based material sheet disposed upon a surface of a porous substrate. In the illustrated embodiment, the substrate pore is shown as having a narrowing of the pore diameter at the pore exit. In the illustrated embodiment, a chemical reaction is activated to anchor the particle at the pore exit. Activation in this case is introduced to the surface of the membrane without the graphene-based material (also designated the backside of the membrane). A chemical reaction can be activated variously, by providing a reagent or catalyst or by providing activating energy, such as heat, light or activating ions or particles. The angled lines indicate at least for application of electromagnetic radiation or beams of electrons, ions or the like, that irradiation or bombardment can be applied at an angle with respect to the surface such that only a portion of the length of the pore is contacted. For example, an appropriate chemical reagent is applied as illustrated to initiate reaction between reactive groups on the particle and at the pore exit.

FIGS. 14A and 14B schematically illustrates another exemplary occlusion of uncovered pores in a composite membrane having a graphene-based material sheet disposed upon a porous substrate. In the illustrated embodiment, the substrate pore is shown in FIGS. 14A and B as having a narrowing of the pore diameter at the pore exit. In the illustrated embodiment, after introduction of the particle into the pore energy is applied to the back side of the membrane as shown to cause a change to the occluding particle, such as deformation as shown in FIG. 14B. The occluding particle may be sensitive to applied energy, such as light of selected wavelengths, or contact with electron or ion beams. The applied energy facilitates deformation of the particle in the uncovered pore facilitating anchoring of the particle in the pore.

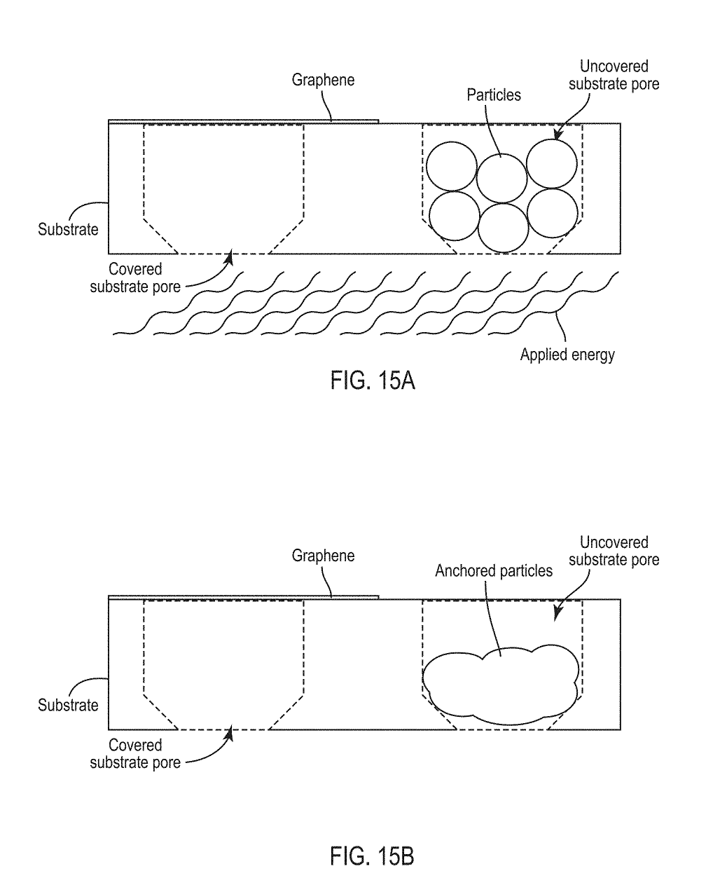

FIGS. 15A and B schematically illustrate another exemplary occlusion of uncovered pores in a composite membrane having a graphene-based material sheet disposed upon a porous substrate. In the illustrated embodiment, the substrate pore is shown as having a narrowing of the pore diameter at the pore exit. In the illustrated embodiment of FIG. 15A, a plurality of particles is shown as introduced into the uncovered pore. In the illustrated embodiment, the particles and/or the pore surfaces or edges carry reactive chemical groups. In the illustrated embodiment of FIG. 15A, energy, for example in the form of light of selected wavelength, an electron or ion beam, or a chemical reagent is applied to the bottom side of the composite membrane to activate chemical reactions between particles and/or between particles and the pores surfaces or edges to facilitate anchoring of particle in the uncovered pore. The result of application of energy is shown in FIG. 15B where the particles are anchored in the substrate pore

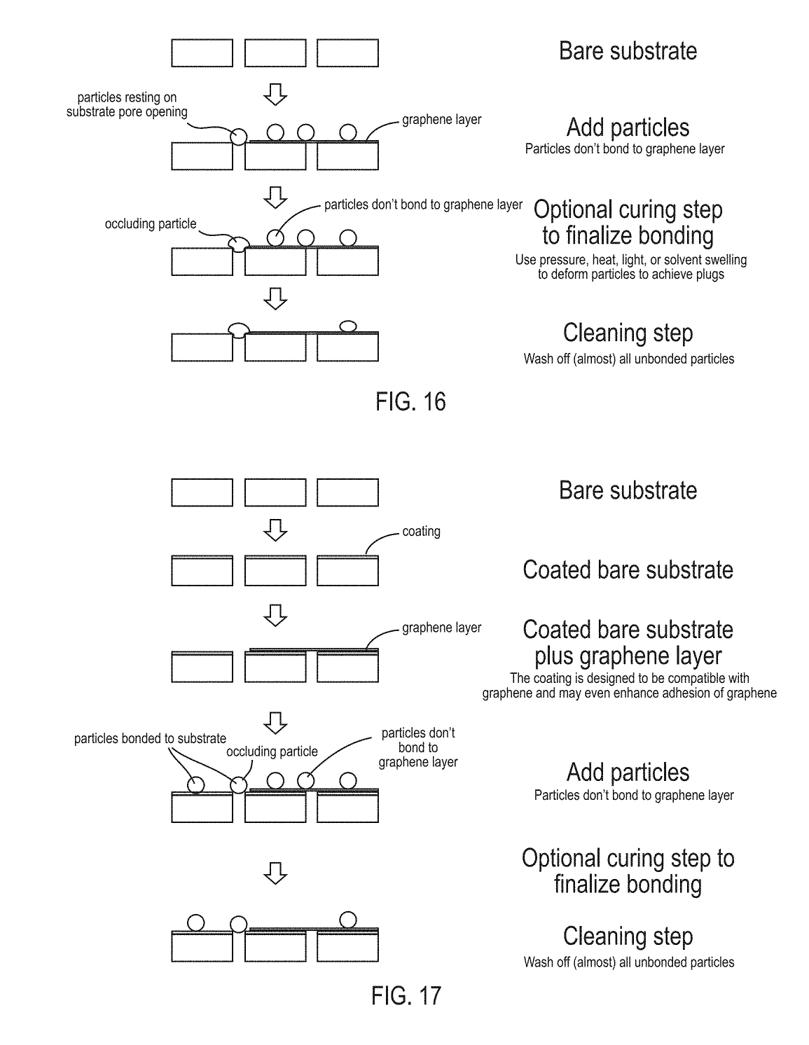

FIG. 16 schematically illustrates steps in an exemplary uncovered pore occlusion process. A graphene sheet is disposed on a porous substrate, illustrated with uniform pores, to form a composite membrane. A portion of the pores are covered by the graphene and a portion of the pores are not covered by the graphene (uncovered pores). Particles sized to at least partially enter an uncovered pore are introduced to the top surface of the composite membrane where they enter uncovered pores, but not covered pores. In the illustrated embodiment, pressure, heat, or light or alternatively solvent swelling is applied to the particles in the uncovered pores to deform the particles or swell the particles to occlude the pores. Particles do not bond to the graphene. The particles are optionally subjected to an optional curing step after deformation. The curing step is for example a thermoset cure achieved by heating. An alternative exemplary cure is achieved catalytically by exposure to a catalyst or curing agent. A cleaning step is then applied to wash off and remove excess particles. The steps of introducing the particles, application of pressure, energy or solvent swelling, and cleaning are repeated until a desired level of pore occlusion is obtained.

FIG. 17 schematically illustrates steps in an exemplary uncovered pore occlusion process. A porous substrate is provided with a coating which is compatible with graphene and may enhance adhesion to graphene. The coating provided does not occlude substrate pores. A graphene sheet is then disposed on the coated porous substrate, illustrated with uniform pores to form a composite membrane. A portion of the pores are covered by the graphene and a portion of the pores are not covered by the graphene (uncovered pores). Particles sized to at least partially enter an uncovered pores are introduced to the top surface of the composite member where they enter uncovered pores, but not covered pores. In the illustrated embodiment, particles optionally bond to the substrate or to the coating on the substrate to facilitate anchoring of the particles to occlude uncovered pores. Particles do not bond to the graphene. The particles may be subjected to an optional curing step after bonding. A cleaning step is then applied to wash off and remove excess particles. The steps of introducing the particles, bonding and optionally curing of particles, and cleaning are repeated until a desired level of pore occlusion is obtained.

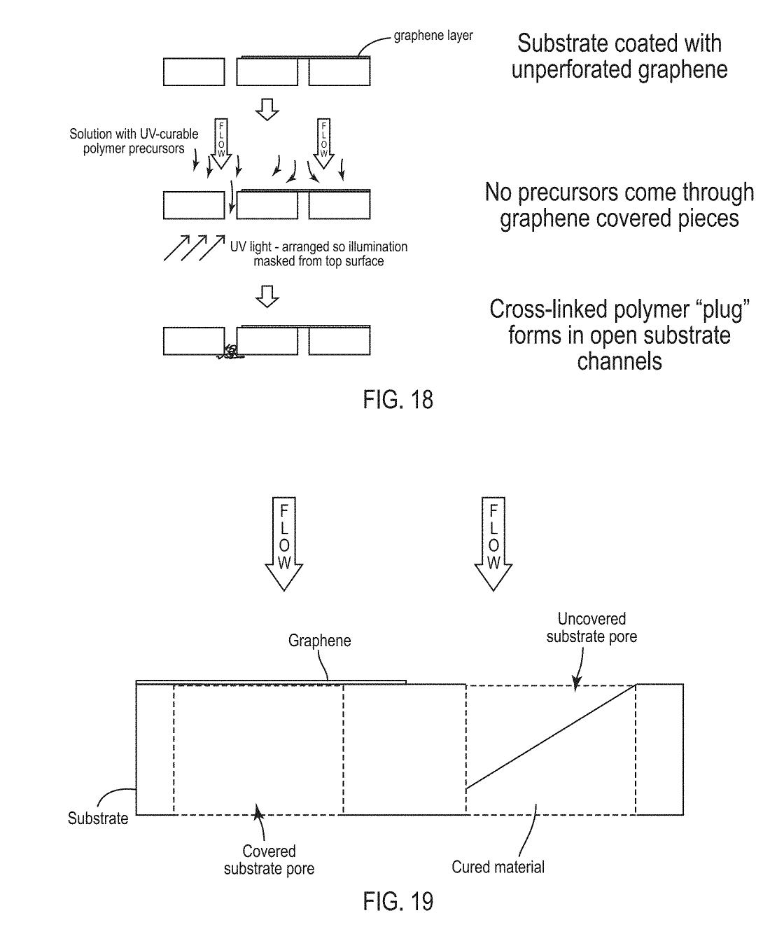

FIG. 18 schematically illustrates steps in an exemplary uncovered pore occlusion process. A graphene sheet is disposed on a porous substrate, illustrated with uniform pores to form a composite membrane. A portion of the pores are covered with the graphene and a portion of the pores are not covered by the graphene (uncovered pores). Polymerizable monomers or oligomers or a curable or cross-linkable polymer are introduced into the uncovered pores. These precursors do not enter graphene covered pores. The precursors are polymerized, cured or cross-linked within the uncovered pores to occlude the pores. Polymerization or curing can be facilitated by application of heat, light of selected wavelength or of chemical reagents including polymerization catalyst and/or cross-linking agents. A cleaning step is then applied to wash off and remove excess unreacted precursors and any catalysts or reagents employed. The steps of introducing precursors for polymerization, curing or cross-linking, polymerization, curing and/or cross linking and cleaning are repeated until a desired level of pore occlusion is obtained.

FIG. 19 schematically illustrates exemplary results of occlusion of uncovered pores as in the process of FIG. 18. In the illustrated embodiment, the substrate pores are shown as having uniform diameter along their length. Shaped pores can also be employed. The illustrated embodiment shows the formation of a cured material or polymer within the uncovered pore to occlude the pore. The direction of flow for introduction of occluding moieties is illustrated as flow perpendicular to the substrate top surface. It will be appreciated that flow can also be applied in the illustrated embodiments in a cross-flow configuration, where flow is parallel to the substrate top surface.

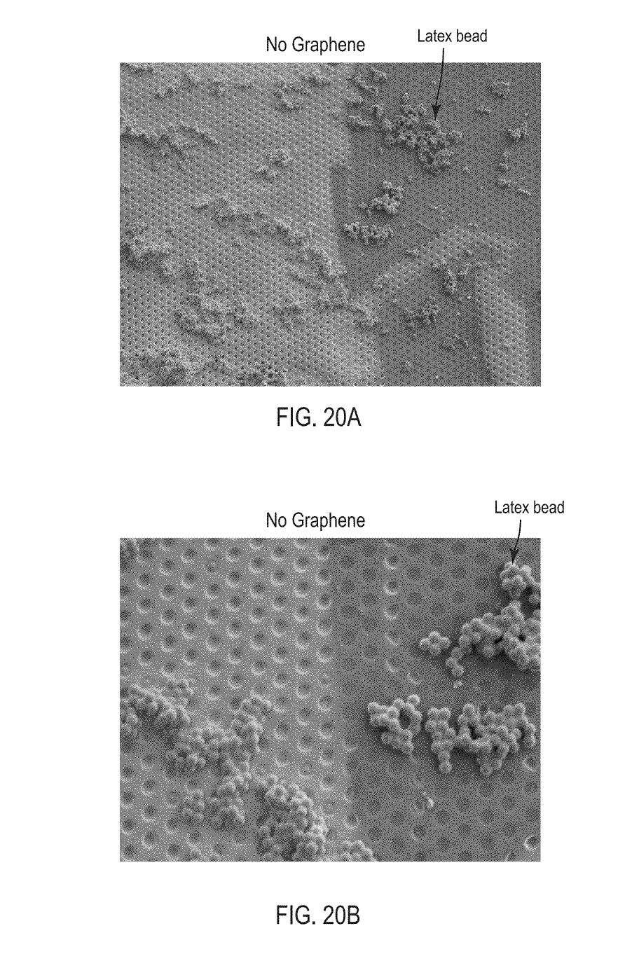

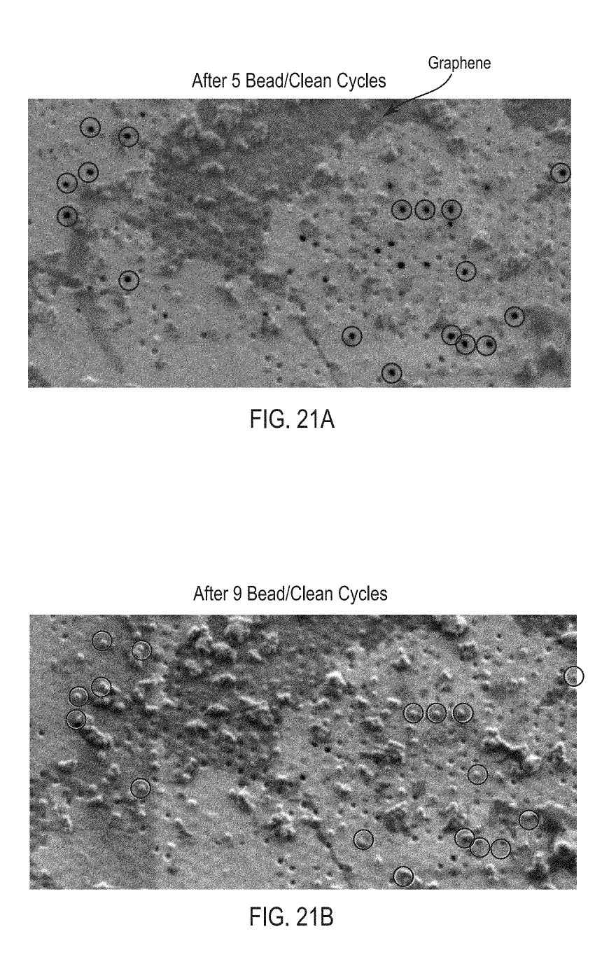

FIGS. 20A and 20B are scanning electron microscopy (SEM) images illustrating latex bead healing (occlusion) of uncovered pores in a composite membrane. The SEM images were taken while tilted at 35-degrees relative to normal of the substrate surface. Areas covered in graphene are dark gray and areas without graphene coverage are light gray. FIG. 20A is a lower magnification (x2500) SEM image showing areas on the composite membrane that are covered or not covered by graphene. Substrate pores (450 nm diameter) which are uncovered by graphene are being occluded by latex beads. Latex beads are also shown clumping on the surface of the composite membrane. Latex beads do not damage the graphene. Pores in the substrate that are uncovered by graphene are being occluded by the latex beads. FIG. 20B is a higher magnification SEM image (x8500) of the same composite membrane showing latex beads occluding uncovered pores in the substrate. Those latex beads which are occluding substrate pores are visible embedded at varying depths into the substrate pores.

FIGS. 21A and 21B are SEM images illustrating the progress of latex bead healing (occlusion) of uncovered pores in a composite membrane. Latex beads of particle size 0.46 μm were employed to occlude substrate pores of 0.45 μm. The graphene sheet is light gray and a large area of dark gray is a microdefect in the graphene. A number of apertures in the graphene are circled in the images. FIG. 21A is an image taken after 5 cycles of alternating latex bead introduction and cleaning, both via cross-flow across the membrane surface. Latex beads were introduced at a 1 ppm dilution in DI water containing 0.1% polysorbate-80 and a biocide (50 ppm NaI₃). Cleaning cycles were performed with the same solution sans latex beads. A three-port flow apparatus with input and output ports allowed for flow across the surface of the graphene-coated surface of composite membrane plus “permeate” flow through membrane. Most uncovered pores are occluded after 5 cycles of alternating latex bead introduction and cleaning, but the circled pores are not occluded. FIG. 21B is an image taken after another 4 of alternating latex bead introduction and cleaning (a total of 9 cycles). Additional apertures are occluded in this second image including all of the apertures circled in the image. The occlusion process illustrated in these images was found however not to be optimized. In particular, it was found that variation of the concentration of the occluding particles in the flow introduced to the membrane could affect efficiency of the occlusion process. It was also found that addition of a surfactant with the flow of particles reduced aggregation and clumping of particles. Clumping of particles on the membrane top surface is preferably minimized or avoided.

FIG. 23A is a SEM image showing occlusion of 1250 nm diameter pores in a silicon nitride substrate by a single graphene sheet, while FIG. 23B is a SEM image of occlusion of 1250 nm diameter pores in a silicon nitride substrate after subsequent application of a second sheet of graphene. As can be seen, a majority of uncovered pores resulting from defects in the first graphene sheet are subsequently occluded by the second graphene sheet. Thus, layering of individual sheets of the two-dimensional material is an effective method for occluding pores in a composite membrane that arise from intrinsic or native defects and defects generated during the processing and handling of the two-dimensional material. Occlusion of the substrate pores can be significantly improved when subsequent sheets of the two dimensional material are applied, because the intrinsic or native defects and defects generated during processing and handling are independent for each layer thus the probability of an unoccluded substrate pore is exponentially reduced with each successive layer. Such a method is most effective for fabrication of a size-selective composite membrane when the size-selected perforations are introduced to the multi-layer stack of two-dimensional materials. In some embodiments, the methods described herein for occluding apertures in a sheet of a two-dimensional material may then be beneficially employed to a multi-layer stack of two dimensional materials.

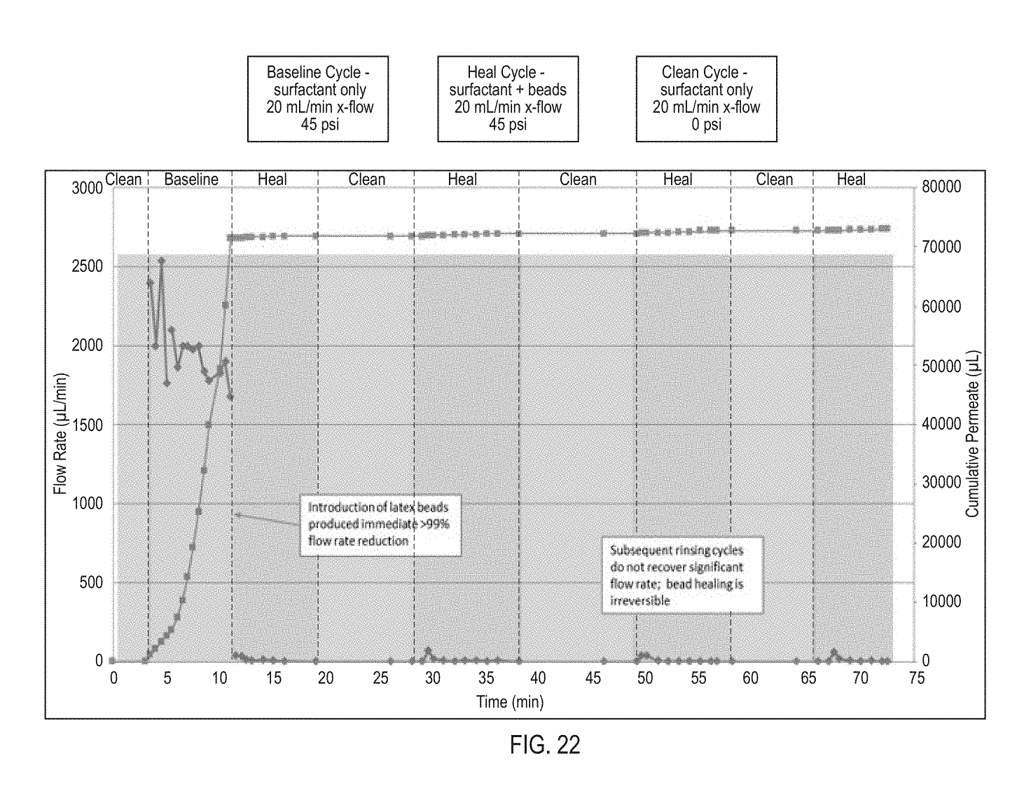

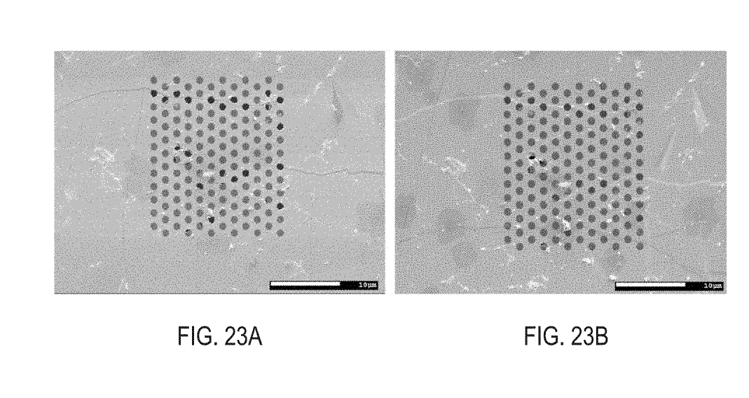

FIG. 22 is a graph of flow rate (μL/min) (left axis, diamonds) and cumulative permeate (right axis, squares) as a function of time through a graphene coated composite membrane that is being subjected to uncovered pore occlusion employing latex particles. Thus the y-axis in FIG. 22 corresponds to the flow rates through the membrane (input-to-permeate). The flow rates noted are the cross-membrane (input-to-output) rates, while the pressures noted are the pressure difference between graphene side of membrane and the permeate outlet. The flows that are cross-membrane (input-to-output) are labeled as “x-flow” in FIG. 22, and should not be confused with the y-axis of the graph of FIG. 22. The occlusion process employed to obtain the illustrated results differed from that illustrated in FIGS. 21A and 21B, in that the concentration of particles applied to the top surface was optimized to improve efficiency of occlusion. The porous substrate of the composite membrane is etched silicon nitride in a rigid silicon support. The silicon nitride has a plurality of patterned 0.45 μtm pores. The composite membrane is assessed in a cross-flow arrangement with pressure applied as indicated. A three-port flow apparatus with input and output ports allowed for flow across the surface of the graphene-coated surface of composite membrane plus “permeate” flow through membrane. A baseline cycle in which an aqueous solution containing only surfactant (0.1% polysorbate-80) with 20 mL/min flow at 45 psi is initially applied. An occlusion cycle includes a step of introduction of latex beads (0.46 μm beads) and a subsequent cleaning step. The latex beads are carried in aqueous solution at a concentration of 0.5 ppm (0.1% polysorbate-80 and biocide (50 ppm NaI₃) and introduced in cross-flow to the composite membrane at 20 mL/min at 45 psi. The cleaning step is cross-flow application of an aqueous solution containing surfactant at a 20 mL/min flow at 0 psi to remove latex beads remaining on surface. The occlusion step and cleaning step are applied for 7-11 minutes as indicated in FIG. 22. The figure follows flow rate and cumulative permeate for three full occlusion/cleaning cycles. Introduction of latex beads in the first occlusion step is shown to produce an immediate greater than 99% reduction in flow rate. Cleaning steps induce a small flow rate recovery (<5% of the flow rate before occlusion), which is then reversed by subsequent occlusion steps. Similarly, cumulative permeate levels off immediately on introduction of the latex beads. No increase in flow rate or the rate of accumulation of permeate is observed on application of additional occlusion cycles. In an embodiment, the concentration of beads may set according to the desired result. In an embodiment, small beads may be introduced, while larger beads are used to remove the small beads in the cleaning step. In an embodiment where bead agglomeration is not detrimental, the agglomerated beads may provide a filtering function.

Although the disclosure has been described with reference to the disclosed embodiments, one having ordinary skill in the art will readily appreciate that these are only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description.

Every formulation or combination of components described or exemplified can be used to practice the inventive concepts disclosed herein, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials and synthetic methods other than those specifically exemplified can be employed in the practice of the inventive concepts disclosed herein without resort to undue experimentation. All art-known functional equivalents, of any such methods, device elements, starting materials and synthetic methods are intended to be included in this inventive concepts disclosed herein. Whenever a range is given in the specification, for example, a temperature range, a time range, or a composition range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The inventive concepts disclosed herein illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the inventive concepts disclosed herein claimed. Thus, it should be understood that although the present inventive concepts disclosed herein has been specifically disclosed by preferred embodiments and optional features, modification and variation of the concepts herein disclosed may be resorted to by those skilled in the art, and that such modifications and variations are considered to be within the scope of the inventive concepts disclosed herein as defined by the appended claims.

In general the terms and phrases used herein have their art-recognized meaning, which can be found by reference to standard texts, journal references and contexts known to those skilled in the art. The preceding definitions are provided to clarify their specific use in the context of the inventive concepts disclosed herein.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the inventive concepts disclosed herein pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

1. A method comprising:
introducing a composite membrane comprising a porous substrate having a plurality of pores and a sheet of two-dimensional material disposed on a surface of the porous substrate and defining a top surface of the membrane, wherein the sheet of two-dimensional material covers at least a portion of the pores of the substrate and wherein at least one pore of the substrate is not covered by the two-dimensional material;
introducing one or more occluding moieties at least partially into the at least one uncovered pore to occlude the at least one uncovered pore.

2. The method of claim 1, wherein the one or more occluding moieties are particles sized for at least partial introduction into an uncovered pore, but which cannot exit the uncovered pore.

3. The method of claim 1, wherein the particles are deformable or swellable.

4. The method of claim 3, wherein the particles are deformable and pressure or energy is applied to the particles after they are introduced into the at least one uncovered pore.

5. The method of claim 4, wherein heat or light of a selected wavelength is applied to the particles after they are introduced into the at least one uncovered pore.

6. The method of claim 4, wherein an electron or ion beam is applied to the particles after they are introduced into the at least one uncovered pore.

7. The method of claim 3, wherein the particles are swellable and the particles are contacted with an absorbable fluid after they are introduced into the at least one uncovered pore.

8. The method of claim 1, wherein the particles carry one or more chemical reactive groups for reaction with compatible reactive groups in the at least one uncovered pore, on the surface of the substrate at the uncovered pore or on other particles to facilitate anchoring of at least one particle in at least one uncovered pore.

9. The method of claim 4, wherein the particles carry an amine or a carboxylate group and the compatible reactive groups are amine-reactive groups or carboxylate reactive groups, respectively.

10. The method of claim 1, wherein the occluding moieties are selected from one or more monomers, oligomers, uncured polymers or uncross-linked polymers and wherein the monomers, oligomers or polymers are polymerized, cured or cross-linked after they are introduced into the at least one uncovered pore.

11. The method of claim 1, wherein the pores of the substrate are shaped to retain the one or more occluding moieties.

12. The method of claim 1, wherein the pores are tapered such that the pore exit diameter is smaller than the pore entrance diameter.

13. The method of claim 1, further comprising a second step of introducing secondary particles into the at least one uncovered pore having a first particle therein occluding the uncovered pore, wherein the secondary particles are sized to be smaller than the first particle.

14. The method of claim 1, wherein the composite membrane further comprises a coating layer on the top surface of the porous substrate between that surface and the sheet of two-dimensional material.

15. The method of claim 14, wherein the occluding moiety is a particle carrying reactive groups which react with the coating layer at the at least one uncovered pore to anchor the particle therein.

16. The method of claim 1, further comprising a step of cleaning the top surface to remove occluding moieties that are not occluding uncovered pores.

17. The method of claim 16, further comprising repeating the introduction and cleaning steps until a selected level of uncovered pore occlusion is achieved.

18. The method of claim 17, wherein introduction and cleaning steps are repeated until at least 80% of the uncovered pores are occluded.

19. The method of claim 17, wherein introduction and cleaning steps are repeated until at least 95% of the uncovered pores are occluded.

20. The method of claim 17, wherein introduction and cleaning steps are repeated until flow rate through the composite membrane decreases by at least 50%.

21. The method of claim 17, wherein introduction and cleaning steps are repeated until flow rate through the composite membrane decreases by at least 95%.

22. The method of claim 1, wherein the two-dimensional material is a graphene-based material.

23. The method of claim 1, wherein the two-dimensional materials is a sheet of graphene.

24. The method of claim 1, wherein the occluding moieties are particles selected from metal particles, silica particles, particles of metal oxide, or polymer particles.

25.-27. (canceled)

28. A composite membrane comprising a porous substrate having a plurality of pores and a sheet of two-dimensional material disposed on a surface of the porous substrate and defining a top surface of the membrane, wherein the sheet of two-dimensional material covers at least a portion of the pores of the substrate, wherein at least one pore of the substrate is not covered by the two-dimensional material and wherein at least one uncovered pore of the substrate is occluded with an occluding moiety.

29. The composite membrane of claim 28, wherein the at least one uncovered pore is occluded with one or more particles or is occluded with a polymer, cured polymer or cross-linked polymer formed in the at least one uncovered pore.

30.-38. (canceled)
